(19) United States
(12) Patent Application Publication
(10) Pub. No.: US 2024/0087174 A1
(43) Pub. Date: Mar. 14, 2024

(54) CODING AND DECODING POINT CLOUD ATTRIBUTE INFORMATION

(71) Applicant: Tencent Technology (Shenzhen) Company Limited, Shenzhen (CN)

(72) Inventor: Wenjie ZHU, Shenzhen (CN)

(73) Assignee: Tencent Technology (Shenzhen) Company Limited, Shenzhen (CN)

(21) Appl. No.: 18/512,223

(22) Filed: Nov. 17, 2023

Related U.S. Application Data
(63) Continuation of application No. PCT/CN2022/123793, filed on Oct. 8, 2022.

(30) Foreign Application Priority Data
Dec. 6, 2021 (CN) 202111478233.9

(51) Int. Cl. G06T 9/00

(52) U.S. Cl. CPC G06T 9/001

(57) ABSTRACT

A point cloud including a plurality of points is acquired. Each of the plurality of points includes N pieces of attribute information. N is a positive integer greater than 1. A to-be-coded value is determined for each of the N pieces of attribute information of a current point of the plurality of points based on the N pieces of attribute information of a point prior to the current point being encoded. The to-be-coded values of the N pieces of attribute information of the current point are encoded based on at least one of a selected encoder or a selected coding mode to obtain a code stream of the point cloud. The to-be-coded value for each of the N pieces of attribute information of the current point is encoded based on a respective one of the one or more encoders and a respective one of the one or more coding modes.

### RELATED APPLICATIONS

The present application is a continuation of International Application No. PCT/CN2022/123793, entitled “METHOD, APPARATUS AND DEVICE FOR CODING AND DECODING POINT CLOUD ATTRIBUTE INFORMATION, AND STORAGE MEDIUM” and filed on Oct. 8, 2022, which claims priority to Chinese Patent Application No. 202111478233.9, entitled “METHOD, APPARATUS AND DEVICE FOR CODING AND DECODING POINT CLOUD ATTRIBUTE INFORMATION, AND STORAGE MEDIUM” and filed on Dec. 6, 2021. The entire disclosures of the prior applications are hereby incorporated by reference in their entirety.

### FIELD OF THE TECHNOLOGY

This application relates to the technical field of video coding and decoding, including coding/decoding point cloud attribute information of a point cloud.

### BACKGROUND OF THE DISCLOSURE

The surface of an object is collected through an acquisition device to form point cloud data, and the point cloud data include hundreds of thousands or even more points. In the video making process, the point cloud data is transmitted between a video making device and a point cloud coding device in a point cloud media file form. However, such a great number of points bring challenges to transmission. Therefore, the video producing device needs to compress the point cloud data before transmission.

The compression of the point cloud data mainly includes the compression of position information and the compression of attribute information. In the compression of the attribute information, a plurality of types of attribute information of the point cloud are compressed one by one, for example, the color attribute of the point cloud is coded, and then the reflectivity attribute of the point cloud is coded.

### SUMMARY

An embodiment of this disclosure provides a method, apparatus and device for coding and decoding point cloud attribute information, and a storage medium, aiming to improve the flexibility in coding and decoding of the point cloud attribute information.

According to an aspect of the disclosure, a method for encoding point cloud attribute information of a point cloud is provided. In the method, a point cloud including a plurality of points is acquired. Each of the plurality of points includes N pieces of attribute information. N is a positive integer greater than 1. A to-be-coded value is determined for each of the N pieces of attribute information of a current point of the plurality of points based on the N pieces of attribute information of another point of the plurality of points being encoded. At least one of (i) an encoder among plural encoders or (ii) a coding mode among plural of coding modes are selected for the to-be-coded value for each of the N pieces of attribute information of the current point. The to-be-coded values of the N pieces of attribute information of the current point are encoded respectively based on the selected at least one of the encoder or the coding mode for each to-be-coded value to obtain a code stream of the point cloud.

According to another aspect of the disclosure, a method for decoding point cloud attribute information of a point cloud is provided. In the method, a code stream of a point cloud that includes a plurality of points is received. Each of the plurality of points includes N pieces of attribute information. N is a positive integer greater than 1. Each of the N pieces of attribute information includes a respective to-be-decoded value. At least one of (i) a decoder among plural decoders or (ii) a decoding mode among plural of decoding modes are selected for the to-be-decoded value for each of the N pieces of attribute information of a current point of the plurality of points. The to-be-decoded values of the N pieces of attribute information of the current point are decoded respectively based on the selected at least one of the decoder or the decoding mode for each to-be-decoded value in response to the N pieces of attribute information of another point of the plurality of points being decoded. A reconstruction value for each of the N pieces of attribute information of the current point is obtained based on the decoded to-be-decoded value of the respective one of the N pieces of attribute information of the current point.

According to another aspect of the disclosure, an apparatus is provided. The apparatus includes processing circuitry. The processing circuitry can be configured to perform any of the described methods for encoding/decoding point cloud attribute information of a point cloud.

Aspects of the disclosure also provide a non-transitory computer-readable medium storing instructions which when executed by a computer cause the computer to perform the method for encoding/decoding point cloud attribute information of a point cloud.

### BRIEF DESCRIPTION OF THE DRAWINGS

FIG. 1 is a schematic block diagram of a system for coding and decoding a point cloud according to an embodiment of this disclosure;

FIG. 2 is a schematic block diagram of a coding framework according to an embodiment of this disclosure;

FIG. 3 is a schematic block diagram of a decoding framework according to an embodiment of this disclosure;

FIGS. 4A, 4B, 4C, and 4E are flowcharts of a method for coding point cloud attribute information according to an embodiment of this disclosure;

FIG. 5A is a schematic diagram of a point cloud ordering mode according to an embodiment of this disclosure;

FIG. 5B is a schematic diagram of another point cloud ordering mode according to an embodiment of this disclosure;

FIG. 5C is a schematic diagram of a reference point search process according to an embodiment of this disclosure;

FIGS. 6A, 6B, and 6C are flowcharts of a method for decoding point cloud attribute information according to an embodiment of this disclosure;

FIG. 7 is another flowchart of a method for decoding point cloud attribute information according to an embodiment of this disclosure;

FIG. 8 is a schematic block diagram of an apparatus for coding point cloud attribute information according to an embodiment of this disclosure;

FIG. 9 is a schematic block diagram of an apparatus for decoding point cloud attribute information according to an embodiment of this disclosure; and

FIG. 10 is a schematic block diagram of an electronic device according to an embodiment of this disclosure.

### DESCRIPTION OF EMBODIMENTS

Technical solutions in embodiments of this disclosure are described below in combination the accompanying drawings in the embodiments of this disclosure.

It is to be understood that in the embodiments of this disclosure, “B corresponding to A” indicates that B is associated with A. In one embodiment, B can be determined based on A. But it is also to be understood that determining B based on A does not mean determining B solely based on A, and B can also be determined based on A and/or other information.

In the description of this disclosure, unless otherwise specified, “a plurality of” refers to two or more.

In addition, in order to facilitate a clear description of the technical solution of the embodiments of this disclosure, the words “first”, “second”, etc. are used for distinguishing the same or similar items with basically the same function and function in the embodiments of this disclosure. Those skilled in the art can understand that the words “first”, “second”, etc. do not limit the quantity and execution order, and the words “first”, “second”, etc. are not necessarily different. In order to facilitate the understanding of the embodiments of this disclosure, the relevant concepts involved in the embodiments of this disclosure are briefly introduced as follows:

Point cloud refers to a group of randomly distributed discrete point sets representing spatial structures and surface attributes of a three-dimensional object or a three-dimensional scene in space.

Point cloud data is an exemplary record form of the point cloud, and points in the point cloud may include position information and attribute information of the points. For example, the position information of the points can be the three-dimensional coordinate information of the points. The position information of the points can also be called geometry information of the points. For example, the attribute information of the points may include color information and/or reflectivity and the like. For example, the color information may be information on any color space. For example, the color information may be (RGB). For another example, the color information may be luminance/chrominance (YcbCr, YUV) information. For example, Y represents luminance (Luma), Cb (U) represents blue chromatic aberration, Cr (V) represents red, and U and V represent chrominance (Chroma) for describing chromatic aberration information. For example, the points in the point cloud obtained according to a laser measurement principle may include three-dimensional coordinate information of the points and laser reflectance of the points. For another example, the points in the point cloud obtained according to a photogrammetry principle may include three-dimensional coordinate information of the points and color information of the points. For another example, the points in the point cloud obtained by combining laser measurement and photogrammetry principles may include three-dimensional coordinate information of the points, laser reflectance of the points and color information of the points.

The acquisition approach of point cloud data may include, but be not limited to, at least one of the following: (1) Generate by a computer device. The computer device may generate the point cloud data according to a virtual three-dimensional object and a virtual three-dimensional scene. (2) Acquire by 3-Dimension (3D) laser scanning. The point cloud data of a static real-world three-dimensional object or a three-dimensional scene can be acquired through 3D laser scanning, and million-level point cloud data can be acquired per second. (3) Acquire by 3D photogrammetry. A real-world visual scene is acquired through a 3D photography device (namely a camera set or a camera device with a plurality of lenses and sensors) so as to acquire the point cloud data of the real-world visual scene, and the point cloud data of a dynamic real-world three-dimensional object or a three-dimensional scene can be acquired through 3D photography. (4) Acquire the point cloud data of biological tissues and organs through a medical device. In the medical field, the point cloud data of biological tissues and organs can be acquired through medical devices such as a magnetic resonance imaging (MRI) device, a computed tomography (CT) device, and an electromagnetic positioning information device.

In an embodiment, the point cloud can be divided into an intensive point cloud and a sparse point cloud according to the acquisition approach.

In an embodiment, the point clouds can be divided into the following types according to the time sequence type of the data:

(1) a static point cloud: an object in the static cloud is static, and a device for acquiring the point cloud is also static.

(2) a dynamic point cloud: an object in the dynamic point cloud is moving, but the device for acquiring the point cloud is static.

(3) a dynamically acquired cloud point: a device in the dynamically acquired could point for acquiring the point cloud is moving.

The point cloud is divided into two types according to the purposes:

(1) a machine perception point cloud: the machine perception point cloud can be applied to scenes such as an autonomous navigation system, a real-time inspection system, a geographic information system, a visual sorting robot, and a rescue and relief robot.

(2) a human eye perception point cloud: the human eye perception point cloud can be applied to point cloud application scenes such as digital cultural heritage, free viewpoint broadcast, three-dimensional immersion communication, and three-dimensional immersion interaction.

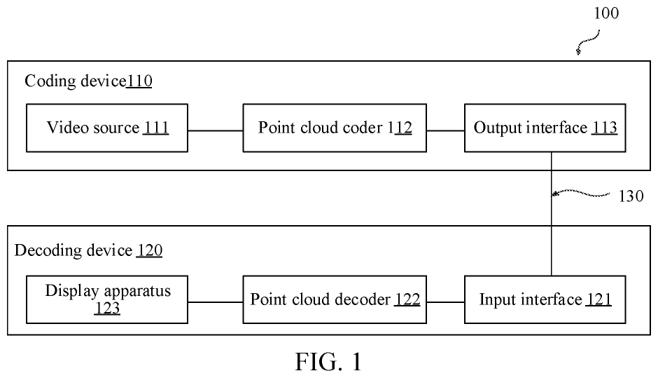

FIG. 1 is a schematic block diagram of a system for coding and decoding a point cloud according to an embodiment of this disclosure. FIG. 1 is only an example, and the system for coding and decoding the point cloud according to the embodiment of this disclosure includes, but is not limited to, FIG. 1. As shown in FIG. 1, the system 100 for coding and decoding the point cloud includes a coding device 110 and a decoding device 120. The coding device 110 is configured to code point cloud data to generate a code stream (it can be understood as compression), and transmit the code stream to the decoding device 120. The decoding device 120 is configured to decode the code stream generated by the coding device 110 by coding to obtain decoded point cloud data.

According to the embodiment of this disclosure, the coding device 110 can be understood as a device having a point cloud coding function, and the decoding device 120 can be understood as a device having a point cloud decoding function, that is, the coding device 110 and the decoding device 120 according to the embodiment of this disclosure may include more apparatus, such as a smart phone, a desktop computer, a mobile computing device, a notebook (like a laptop) computer, a tablet computer, a set top box, a television, a camera, a display apparatus, a digital media player, a video game console and a vehicle-mounted computer.

In some embodiments, the coding device 110 can transmit the coded point cloud data (such as the code stream) to the decoding device 120 via a channel 130. The channel 130 may include one or more media and/or apparatuses capable of transmitting the coded point cloud data from the coding device 110 to the decoding device 120.

In one example, the channel 130 includes one or more communication media that enable the coding device 110 to transmit the coded point cloud data directly to the decoding device 120 in real time. In this example, the coding device 110 may modulate the coded point cloud data according to a communication standard and transmit the modulated point cloud data to the decoding device 120. The communication media may include wireless communication media, such as radio frequency spectrum; and in some embodiments, the communication media may also include wired communication media, such as one or more physical transmission lines.

In another example, the channel 130 includes a storage medium that can store the point cloud data coded by the coding device 110. The storage medium includes a plurality of local access data storage media, such as optical discs, DVDs and flash memories. In this example, the decoding device 120 can acquire the coded point cloud data from the storage medium.

In another example, the channel 130 may include a storage server that can store the point cloud data coded by the coding device 110. In this example, the decoding device 120 can download the stored coded point cloud data from the storage server. In some embodiments, the storage server can store the coded point cloud data and transmit the coded point cloud data to the decoding device 120, such as a web server (e.g., for a website), and a file transfer protocol (FTP) server.

In some embodiments, the coding device 110 includes a point cloud coder 112 and an output interface 113. The output interface 113 may include a modulator/demodulator (modem) and/or a transmitter.

In some embodiments, the coding device 110 may include a video source 111 in addition to the point cloud coder 112 and the output interface 113.

The video source 111 may include at least one of a video acquisition apparatus (e.g., a video camera), a video archive, a video input interface for receiving point cloud data from a video content provider, and a computer graphics system for generating the point cloud data.

The point cloud coder 112 encodes the point cloud data from the video source 111 to generate the code stream. The point cloud coder 112 directly/indirectly transmits the coded point cloud data to the decoding device 120 via the output interface 113. The coded point cloud data may also be stored on the storage medium or the storage server for subsequent reading by the decoding device 120.

In some embodiments, the decoding device 120 includes an input interface 121 and a point cloud decoder 122.

In some embodiments, the decoding device 120 may also include a display apparatus 123 in addition to the input interface 121 and the point cloud decoder 122.

The input interface 121 includes a receiver and/or a modem. The input interface 121 can receive the coded point cloud data through the channel 130.

The point cloud decoder 122 is configured to decode the coded point cloud data to obtain decoded point cloud data, and transmit the decoded point cloud data to the display apparatus 123.

The display apparatus 123 is configured to display the decoded point cloud data. The display apparatus 123 can be integrated with the decoding device 120 or arranged outside the decoding device 120. The display apparatus 123 may include a plurality of display apparatuses, such as a liquid crystal display (LCD), a plasma display, an organic light emitting diode (OLED) display or other types of display apparatus.

In addition, FIG. 1 is only an example, the technical solution of the embodiment of this disclosure is not limited to FIG. 1. For example, the technology of this disclosure can also be applied to single-side point cloud coding or single-side point cloud decoding.

Because the point cloud is a collection of massive points, storing the point cloud not only consumes a large amount of internal memory but also is not conducive to transmission, and there is no such a large bandwidth to support direct transmission of point clouds at the network layer without compression. Therefore, it is necessary to compress the point cloud.

At present, the point cloud can be compressed through a point cloud coding framework.

The point cloud coding framework may be a geometry point cloud compression (G-PCC) coding and decoding framework provided by a moving picture experts group (MPEG), or a video point cloud compression (V-PCC) coding and decoding framework and may also be an AVS-PCC coding and decoding framework provided by an audio video standard (AVS) organization. The G-PCC and the AVS-PCC are both for static sparse point cloud, and relative coding frameworks are approximately the same. The G-PCC coding and decoding framework can be configured to compress a first static point cloud and a third type of dynamically acquired point cloud, and the V-PCC coding and decoding framework can be configured to compress a second type of dynamic point cloud. The G-PCC coding and decoding framework is also called a point cloud codec TMC13, and the V-PCC coding and decoding framework is also called a point cloud codec TMC2.

The G-PCC coding and decoding framework is taken as an example for illustrating the applicable coding and decoding framework in the embodiment of this disclosure.

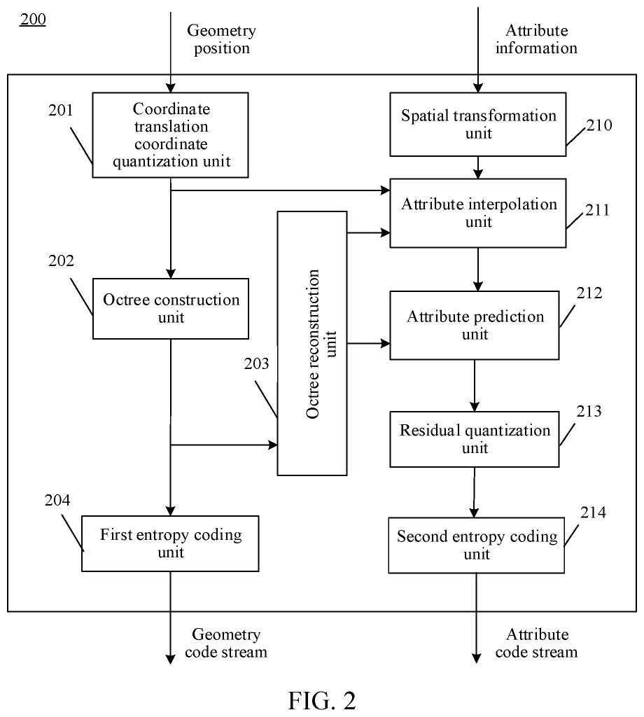

FIG. 2 is a schematic block diagram of a coding framework according to an embodiment of this disclosure.

As shown in FIG. 2, the coding framework 200 can acquire position information (also called geometry information or geometry position) and attribute information of the point cloud from an acquisition device. The coding of the point cloud includes position coding and attribute coding.

In the position coding process, pre-processing, such as coordinate transformation, quantization, and repeated point removal, can be performed on an original point cloud. An octree can be constructed and then coded to form a geometry code stream.

In the attribute coding process, one of three prediction modes can be selected to perform point cloud prediction by giving and inputting reconstruction information of the position information of the input point cloud and a real value of the attribute information. The predicted result can be quantized, and an arithmetic coding can be performed to form an attribute code stream.

As shown in FIG. 2, the position coding can be realized through the following units:

a coordinate translation coordinate quantization unit 201, an octree construction unit 202, an octree reconstruction unit 203 and a first entropy coding unit 204.

The coordinate translation coordinate quantization unit 201 can be configured to transform world coordinates of points in the point cloud into relative coordinates and quantize the coordinates, so that the number of the coordinates can be reduced; and originally different points may be endowed with the same coordinates after quantization.

The octree construction unit 202 can code the position information of the quantized points by an octree coding mode. For example, the point cloud is divided according to the form of the octree, so that the positions of the points can be in one-to-one correspondence with the positions of the octree; and the positions of the points in the octree are counted, and the flag of the points is marked as 1 for geometry coding.

The octree reconstruction unit 203 is configured to reconstruct the geometry position of each point in the point cloud to obtain the reconstructed geometry position of the point.

The first entropy coding unit 204 can perform arithmetic coding on the position information outputted by the octree construction unit 202 in an entropy coding mode, namely, the position information outputted by the octree construction unit 202 is used for generating the geometry code stream by the arithmetic coding mode; and the geometry code stream can also be called a geometry bit stream.

Attribute coding can be implemented through a plurality of units, such as a spatial transformation unit 210, an attribute interpolation unit 211, an attribute prediction unit 212, a residual quantization unit 213 and a second entropy coding unit 214.

The spatial transformation unit 210 can be configured to spatially transform RGB colors of the points in the point cloud into an YCbCr format or other formats.

The attribute interpolation unit 211 can be configured to transform the attribute information of the points in the point cloud so as to minimize attribute distortion. For example, the attribute interpolation unit 211 can be configured to obtain a true value of the attribute information of the points. For example, the attribute information can be the color information of the points.

The attribute prediction unit 212 can be configured to predicate the attribute information of the points in the point cloud so as to obtain a predicted value of the attribute information of the points, and then obtain a residual value of attribute information of the points based on the predicted value of the attribute information of the points. For example, the residual value of attribute information of the points can be obtained by subtracting the predicted value of the attribute information of the points from the true value of the attribute information of the points.

The residual quantization unit 213 can be configured to quantize the residual value of attribute information of the points.

The second entropy coding unit 214 can be configured to carry out entropy coding on the residual value of attribute information of the points through zero run length coding so as to obtain the attribute code stream. The attribute code stream may be bitstream information.

In combination with FIG. 2, the main operation and processing of geometry structure coding in this disclosure are shown as follows:

(1) Pre-processing: the pre-processing includes transform coordinates and voxelization. The point cloud data in the 3D space is transformed into an integer form through scaling and translation operations, and the minimum geometry position of the point cloud data is moved to the origin of coordinates.

(2) Geometry coding: the geometry coding includes two modes and can be used under different conditions: (a) Geometry coding based on octree: the octree is a tree-shaped data structure; in 3D space division, a preset bounding box is uniformly divided, and each node has eight sub-nodes. Occupancy code information is obtained as a code stream of point cloud ceometry information by adopting ‘1’ and ‘0’ to indicate whether each sub-node of the octree is occupied or not. (b) Geometry coding based on trisoup: the point cloud is divided into blocks with a certain size, the intersection points of the surface of the point cloud on the edges of the blocks are positioned and form a triangle. Compression of geometry information is realized by coding the positions of intersection points.

(3) Geometry quantization: the precision of quantization is generally determined by a quantization parameter (QP), and as the value of the QP is large, the coefficients representing a larger value range are quantized as the same output, so large distortion and a lower code rate may be generally caused; on the contrary, if the value of the QP is relatively small, the coefficients within a relatively small value range will be quantized into the same output, which always causes relatively small distortion and relatively upper bit rate. In the point cloud coding, quantization is directly carried out on the coordinate information of the points.

(4) Geometry entropy coding: statistical compression coding is carried out on the occupancy code information of the octree, and finally a binarized (0 or 1) compression code stream is output. The statistical coding is a lossless coding mode, which can effectively reduce the code rate required for representing the same signal. The common statistical coding mode is content adaptive binary arithmetic coding (CABAC).

The main operation and processing of attribute information coding are as follows:

(1) Attribute recoloring: after geometry information coding, a coding end needs to decode and reconstruct the geometry information in a case of lossy coding, that is, coordinate information of each point of a 3D point cloud is recovered. The attribute information corresponding to one or more adjacent points is searched from an original point cloud to serve as the attribute information of the reconstructed point.

(2) Attribute prediction (Predict) and attribute transformation (Transform). In the attribute prediction, a neighbor point of a to-be-coded point in the coded points is determined as a prediction point according to information such as distance or spatial relationship, and a prediction value of the point is computed according to a set criterion. The difference value between the attribute value of the current point and the prediction value is computed as a residual, and quantization, transformation (optional) and entropy coding are carried out on the residual information. In the attribute transformation, the attribute information is grouped and transformed by transformation methods such as discrete cosine transform (DCT) and haar transform (Haar), and the transformation coefficient is quantized; an attribute reconstruction value is obtained after inverse quantization and inverse transformation; the difference between the original attribute and the attribute reconstruction value is computed to obtain an attribute residual, and the attribute residual is quantized; and the quantized transformation coefficient and the attribute residual are coded.

(3) Attribute quantization: the precision of quantization is generally determined by a quantization parameter (QP). In prediction coding, entropy coding is carried out on the residual value after quantization; and in transformation coding, entropy coding is carried out on the transformation coefficient after quantization.

(4) Attribute entropy coding: the quantized attribute residual signal or transformation coefficient is generally subjected to final compression by run length coding and arithmetic coding. In a corresponding coding mode, information such as quantization parameter is also coded by an entropy coder.

As shown in FIG. 2, a point cloud coder 200 mainly includes two parts in function: a position coding module and an attribute coding module; the position coding module is configured to code the position information of the point cloud to form the geometry code stream; and the attribute coding module is configured to code the attribute information of the point cloud to form the attribute code stream. The embodiment of this disclosure mainly relates to the coding of the attribute information.

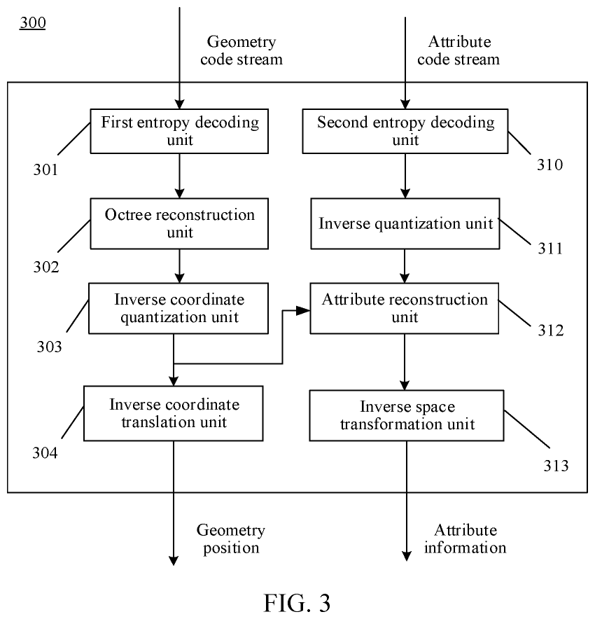

FIG. 3 is a schematic block diagram of a decoding framework according to an embodiment of this disclosure.

As shown in FIG. 3, a decoding framework 300 can acquire the code stream of the point cloud from the coding device and obtain the position information and the attribute information of the points in the point cloud by parsing codes. The decoding of the point cloud includes position decoding and attribute decoding.

In the position decoding process, an arithmetic decoding can be performed on the geometry code stream. The octree can be constructed and then the constructed octree can be combined. The position information of the points can be reconstructed to obtain reconstruction information of the position information of the points. A coordinate transformation can be performed on the reconstruction information of the position information of the points to obtain the position information of the points. The position information of the points can also be called geometry information of the points.

In the attribute decoding process, the residual value of attribute information of the points in the point cloud can be obtained by parsing the attribute code stream. An inverse quantization can be performed on the residual value of attribute information of the points to obtain the inverse quantized residual value of attribute information of the points. One of three prediction modes for point cloud prediction can be selected based on the reconstruction information of the position information of the points obtained in the position decoding process so as to obtain the reconstruction value of the attribute information of the points. A color space inverse transformation can be performed on the reconstruction value of the attribute information of the points to obtain the decoded point cloud.

As shown in FIG. 3, the position decoding can be implemented through a plurality of units, such as a first entropy decoding unit 301, an octree reconstruction unit 302, an inverse coordinate quantization unit 303 and an inverse coordinate translation unit 304.

Attribute coding can be implemented through a plurality of units, such as a second entropy decoding unit 310, an inverse quantization unit 311, an attribute reconstruction unit 312 and an inverse spatial transformation unit 313.

Decompression is an inverse process of compression, and similarly, the function of each unit in the decoding framework 300 can refer to the function of the corresponding unit in the coding framework 200.

At the decoding end, after obtaining the compressed code stream, the decoder firstly performs entropy decoding to obtain various mode information and quantized geometry information and attribute information. Firstly, the geometry information is inversely quantized to obtain reconstructed 3D point position information. On the other hand, the attribute information is inversely quantized to obtain residual information, a reference signal is confirmed according to an adopted transformation mode, thus reconstructed attribute information is obtained and corresponds to the geometry information one to one in sequence, and then output reconstructed point cloud data is generated.

Mode information such as prediction, quantization, coding and filtering or parameter information determined during coding the attribute information by the coding end is carried in the attribute code stream as occasion requires. The decoding end analyzes and determines the mode information such as prediction, quantization, coding and filtering or the parameter information the same as that of the coding end by analyzing the attribute code stream and according to related information, and therefore it is guaranteed that the reconstruction value of the attribute information obtained by the coding end is the same as that of the attribute information obtained by the decoding end.

The process described above is a basic process of the point cloud codec based on the G-PCC coding and decoding framework. With the development of technology, some modules or steps of the framework or the process may be optimized. This disclosure is suitable for the basic process of the point cloud codec based on the G-PCC coding and decoding framework, but not limited to the framework and the process.

In run-length coding, binarization and entropy coding are carried out for transformed signed attribute prediction residual. For example, the attribute prediction residual Res of each point is traversed, and the number run_length of the points of which the continuous attribute prediction residual value is 0 is counted. If the attribute prediction residual Res is non-zero, the run_length value is coded, then the non-zero attribute prediction residual is coded, and finally the run_length value is set to be 0 for counting again. In addition, in run-length coding, each component Res (i=0, 1, 2) of the non-zero attribute prediction residual Resᵢ is coded in sequence. A coding mode associated with run-length coding can include steps as follows:

In step 1, an arithmetic coding can be performed based on whether the attribute residual component Resᵢ of the content is 0 when the attribute information to be coded is color. If the attribute information to be coded is reflectivity, the non-zero attribute prediction residual is not subjected to this step for determining.

In step 2, a bypass coding can be performed on a symbol if Resᵢ is not 0.

In step 3, an arithmetic coding can be performed based on whether the absolute value of the attribute residual component Resᵢ of the content is 1.

In step 4, an arithmetic coding can be performed based on whether the absolute value of the attribute residual component Resᵢ of the content is 2 under a condition that the absolute value of the attribute residual component Resᵢ is more than 1.

In step 5, an exponential Golomb coding can be performed through the context (Resᵢ the absolute value of −3 under a condition that the absolute value of the attribute residual component Resᵢ is more than 2. If the attribute information is the reflectivity, a third-order exponential Golomb code is adopted; and if the attribute information is the color, a first-order exponential Golomb code is adopted.

At present, in the point cloud attribute coding process, a plurality of pieces of attribute information of the point cloud are coded one by one, for example, the color attribute of the point cloud is coded, and then the reflectivity attribute of the point cloud is coded. However, when the attribute information of the point cloud is compressed one by one, coding or decoding of part of the point cloud cannot be implemented, for example, during decoding, the color attributes of all the points in the point cloud are to be decoded, then the reflectivity attributes of all the points in the point cloud can be decoded again, the attribute information of part of the points in the point cloud cannot be decoded, and therefore the flexibility in coding and decoding of the attribute information of the point cloud is poor.

In order to solve the technical problem above, the attribute information of the points in the point cloud is coded point by point during coding in this disclosure, for example, all the pieces of attribute information of the previous point in the point cloud are coded, and then all the pieces of attribute information of the next point in the point cloud are coded. Therefore, during decoding, the attribute information of any one or more points in the point cloud can be decoded, and the flexibility in coding and decoding of the attribute information of the point cloud is further improved. In addition, the attribute information of each point can be coded or decoded in parallel in this disclosure, so that the coding and decoding complexity is reduced, and the coding and decoding efficiency of the point cloud is improved.

The technical solution of the embodiment of this disclosure is described in detail through some embodiments as follows. The following embodiments can be combined with one another, and the same or similar concepts or processes may not be repeated in some embodiments.

Firstly, the coding end is taken as an example to describe the method for coding the point cloud attribute information provided by the embodiment of this disclosure.

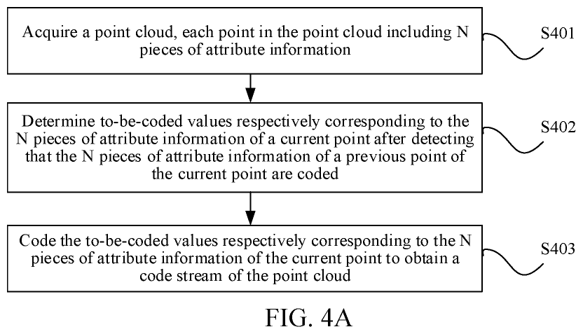

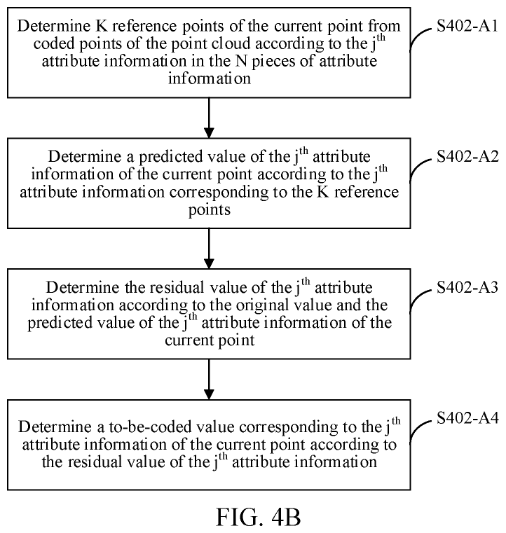

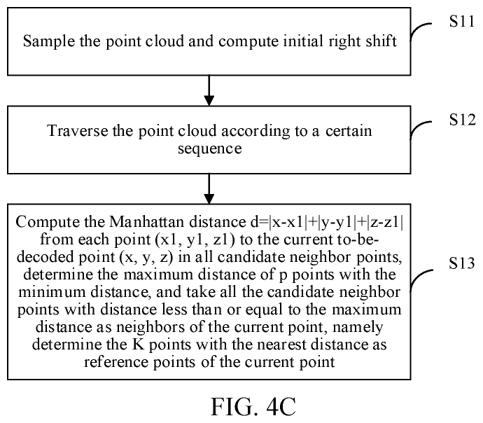

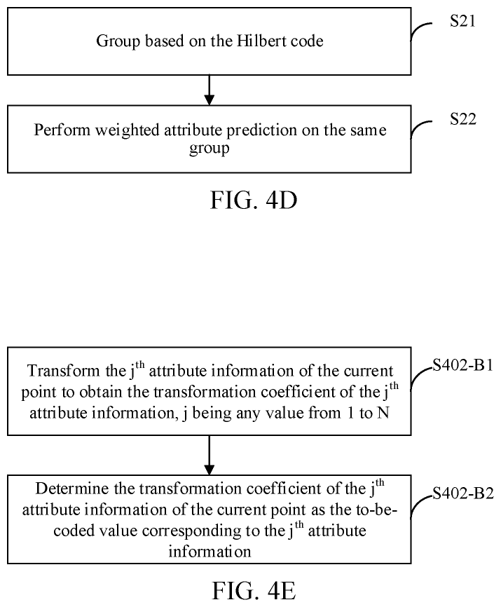

FIG. 4A is a flowchart of a method for coding point cloud attribute information according to an embodiment of this disclosure. An executive agent of the method is an apparatus having a point cloud attribute information coding function, such as a point cloud coding apparatus, and the point cloud coding apparatus can be the abovementioned point cloud coding device or a part of the point cloud coding device. In order to facilitate description, the following embodiment is introduced by taking the point cloud coding device as the executive agent. As shown in FIG. 4A, the method of the embodiment includes:

In step S401, the point cloud can be acquired, where each point in the point cloud includes N pieces of attribute information. N is a positive integer greater than 1.

According to the embodiment of this disclosure, the point cloud can be an integral point cloud or a partial point cloud, such as a partial point cloud obtained through the octree or other modes, like a subset of the integral point cloud.

The point cloud coding device may acquire the point cloud through the following modes:

(1) Mode 1: If the point cloud coding device has the point cloud acquisition function, the point clouds can be acquired by the point cloud coding device.

(2) Mode 2: The point cloud is acquired by the point cloud coding device from other storage devices, for example, a point cloud acquisition device stores the acquired point cloud in the storage device, and the point cloud coding device reads the point clouds from the storage device.

(3) Mode 3: the point cloud is acquired by the point cloud coding device from the point cloud acquisition device, for example, the point cloud acquisition device transmits the acquired point clouds to the point cloud coding device.

If the point cloud is the integral point cloud, the point cloud coding device acquires the integral point cloud by the above mode as a research object of this disclosure for executing subsequent coding step.

If the point cloud above is the partial point cloud, the point cloud coding device divides the obtained integral point cloud to obtain the partial point cloud. For example, the point cloud coding device divides the integral point cloud by an octree or a quadtree and other methods, and takes a partial point cloud corresponding to one node as a research object of this disclosure for executing subsequent coding step.

After the point cloud is obtained according to the abovementioned method, geometry coding and attribute coding are carried out on the points in the point cloud, for example, geometry coding is carried out, and then attribute coding is carried out after geometry coding is finished. This disclosure mainly relates to attribute coding of the point cloud.

The N types of attribute information includes a color attribute, a reflectivity attribute, a normal vector attribute, a material attribute and the like. This disclosure does not limit it.

In step S402, to-be-coded values can be determined respectively corresponding to the N pieces of attribute information of the current point after detecting that N pieces of attribute information of the previous point of the current point are coded.

According to this disclosure, the point cloud attribute coding is carried out point by point, for example, N pieces of attribute information of the previous point in the point cloud are coded, and then N pieces of attribute information of a next point in the point cloud are coded, thus the N pieces of attribute information of each point in the point cloud are independent of one another and do not interfere with one another, the decoding end can decode the attribute information of one or more points in the point cloud conveniently, and the flexibility in coding and decoding of the point cloud is improved.

The current point can be understood as a point which is being coded in the point cloud; during coding the current point, it is needed to determine whether the N pieces of attribute information of the previous point of the current point are coded or not firstly; and after the N pieces of attribute information of the previous point of the current point are coded, the N pieces of attribute information of the current point can be coded.

The attribute information coding process of all points in the point cloud is consistent with the attribute information coding process of the current point, and the current point is taken as an example for illustrating in the embodiment of this disclosure.

During coding the current point, the to-be-coded values respectively corresponding to the N pieces of attribute information of the current point are determined. The coding modes for the N pieces of attribute information can be the same or different, and this disclosure does not limit it. The to-be-coded value can be understood as entropy coding data.

In some embodiments, the coding modes for each of the N pieces of attribute information of the current point are the same, and correspondingly, the types of to-be-coded values respectively corresponding to each of the N pieces of attribute information are the same.

In some embodiments, the coding modes for each of the N pieces of attribute information of the current point are different, and correspondingly, the types of the to-be-coded values respectively corresponding to each of the N pieces of attribute information are different.

In some embodiments, the coding modes of part of the attribute information in the N pieces of attribute information of the current point are the same, and the coding modes for part of the attribute information are different, and correspondingly, the types of the to-be-coded values respectively corresponding to part of the attribute information in the N pieces of attribute information are the same, and the types of the to-be-coded values respectively corresponding to part of the attribute information are different.

In some embodiments, the to-be-coded value corresponding to each of the N pieces of attribute information includes: any one of the residual value of attribute information, the transformation coefficient of attribute information and the transformation coefficient of attribute residual.

In some embodiments, during coding the N pieces of attribute information of the current point, the N pieces of attribute information can be coded in sequence according to the preset coding sequence, for example, the color attribute of the current point is coded, and then the reflectivity attribute of the current point is coded. Or, the reflectivity attribute of the current point is coded, and then the color attribute of the current point is coded. This disclosure does not limit the coding sequence of the N pieces of attribute information of the current point, and it is determined according to actual needs. In some embodiments, the N pieces of attribute information of the current point can be coded in parallel so as to improve the coding efficiency.

If the coding end adopts the preset coding sequence to code the N pieces of attribute information of the current point, the decoding end also decodes the N pieces of attribute information of the current point in sequence according to the coding sequence. In some embodiments, the coding sequence of the N pieces of attribute information is default, so that the decoding end decodes the N pieces of attribute information of the current point in sequence according to the default coding sequence. In some embodiments, if the coding sequence of the N pieces of attribute information adopted by the coding end is not default, the coding end indicates the coding sequence to the decoding end, the decoding end decodes the N pieces of attribute information of the current point in sequence according to the coding sequence, and thus the coding and decoding consistency is ensured.

According to this disclosure, the modes for determining the to-be-coded values respectively corresponding to the N pieces of attribute information of the current point in S402 can include, but are not limited to, a mode 1 and a mode 2.

In mode 1 of step S402, if the to-be-coded value includes the residual value of j^{th} attribute information of the current point or the transformation coefficient of attribute residual, S402 includes steps S402-A1 to S402-A4, which can be as shown in FIG. 4B as follows.

In step S402-A1, K reference points of the current point can be determined from the coded points of the point cloud for the j^{th} attribute information in the N pieces of attribute information of the current point. K is a positive integer, and j is any value from 1 to N.

In mode 1, the j^{th} attribute information in the N pieces of attribute information of the current point is taken as an example for illustrating. The to-be-coded value of each of the N pieces of attribute information of the current point can be determined through mode 1. Or the to-be-coded value of one or more pieces of attribute information in the N pieces of attribute information of the current point can determined through mode 1, and this disclosure does not limit it.

If the to-be-coded value of the j^{th} attribute information of the current point is determined through mode 1, S402-A1 is executed firstly to determine the K reference points of the current point.

In some embodiments, the K reference points of the current point are also called as K predicted points of the current point, or K neighbor points of the current point.

In this step, the mode for determining the K reference points of the current point includes, but is not limited to, an example 1, an example 2, and an example 3.

In example 1, the points in the point cloud can be reordered to obtain a Morton sequence or a Hilbert sequence of the point cloud, and search K points closest to the current point in the first maxNumOfNeighbours (the maximum number of neighbor points) of the Morton sequence or the Hilbert sequence.

In some embodiments, the maxNumOfNeighbours are defaulted to be 128, k is defaulted to be 3, and the distance calculation method is a Manhattan distance, namely d=|x1−x2|+|y1−y2|+|z1−z2|; and in some embodiments, the distance calculation method can also be other distance calculation methods.

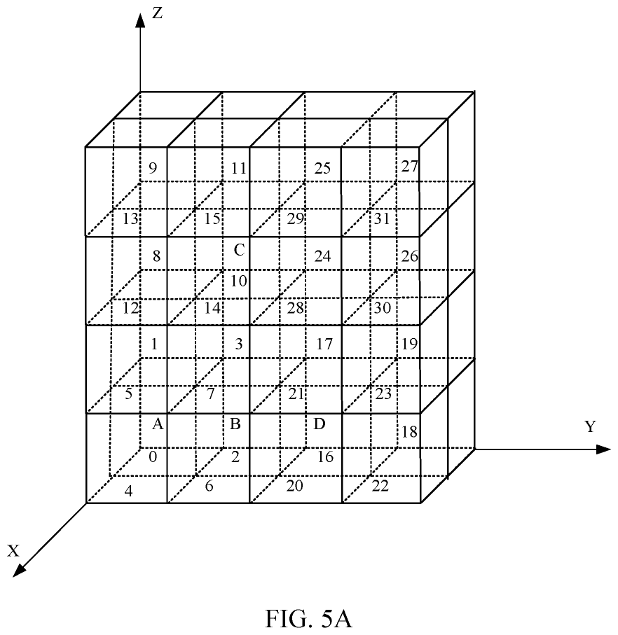

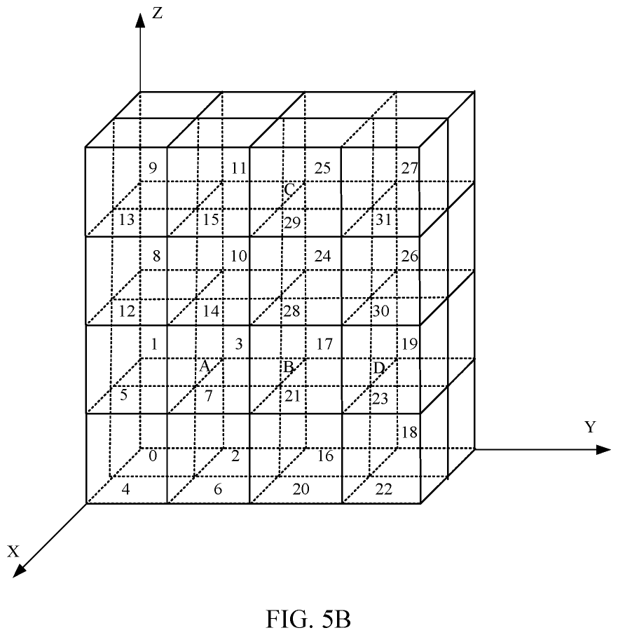

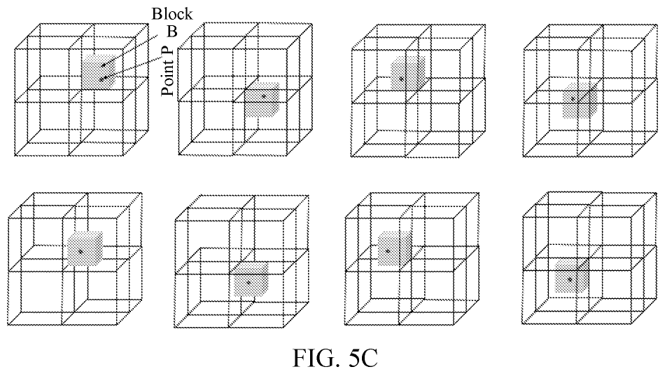

In a possible embodiment, the mode for determining the Morton sequence of the point cloud may include: acquiring coordinates of all point clouds, and obtaining an Morton sequence 1 according to the Morton sequence, which can be shown in the FIG. 5A.

In some embodiments, a fixed value (j1, j2, j3) is added to the coordinates (x, y, z) of all the point clouds, a Morton code corresponding to the point cloud is generated through the new coordinates (x+j1, y+j2, z+j3), and a Morton sequence 2 is obtained according to the Morton sequence, as shown in the FIGS. 5B. A, B, C and D in FIG. 5A move to different positions in FIG. 5B, the corresponding Morton codes are changed, but the relative positions of the Morton codes are kept unchanged. In addition, as shown in FIG. 5B, the Morton code of the point D is 23, and the Morton code of the neighbor point B is 21, so the point B can be found by searching forwards at most two points from the point D. However, as shown in FIG. 5A, the point B (Morton code 2) can be found by searching forwards at most 14 points from the point D (Morton code 16).

According to the Morton sequence, the nearest prediction point of the current point is searched, for example, the first N1 points of the current point are selected from the Morton sequence 1 as candidates, the value range of N1 is larger than or equal to 1, the first N2 points of the current point are selected from the Morton sequence 2 as candidates, and the value range of N2 is larger than or equal to 1.

The N1 points and the N2 points form maxNumOfNeighbours; the distance d between each point and the current point is computed in the maxNumOfNeighbours; the coordinates of the current point are (x, y, x); the coordinates of the candidate points are (x1, y1, z1); and in some embodiments, the distance d calculation method is d=|x−x1|+|y−y1|+|z−z1|, and K decoded points with the minimum distance are selected from the N1+N2 points to serve as reference points of the current point.

In example 2, the points in the point cloud can be reordered to obtain the Morton sequence or the Hilbert sequence of the point cloud, and determine K reference points of the current point based on the spatial relationship and distance of the point cloud in the Morton sequence or the Hilbert sequence. As shown in FIG. 4C, example 2 further includes the following steps:

In step S11, the point cloud can be sampled and an initial right shift can be computed. For example, the size of an initial neighbor range for LOD division search is determined, and an initial right shift number (e.g., the size of the initial neighbor range is 2^{N}^{₀}) is determined. No is determined as a minimum value of a condition that the average neighbor number of points is greater than or equal to 1 when the points in the point cloud are subjected to neighbor search in the neighbor range. If the proportion of neighbors of the sampled points is smaller than 0.6 under this condition, it indicates that the neighbor range is expanded once, namely the value of No is added by 3. After the No is acquired, No+6 is the right shift number corresponding to a current block, and No+9 is the initial right shift number corresponding to a parent block.

In step S12, the point cloud can be traversed according to a certain sequence, as shown in FIG. 5C, and a nearest neighbor search can be performed on decoded points ((limited in the range of previous maxNumOfNeighbours points) for a current to-be-decoded point P to determine neighbors of the current to-be-decoded point P. The nearest neighbor search can be performed in a parent block of a B block where the current to-be-decoded point P is located and in a range of neighbor blocks which are coplanar, collinear and concurrent with the parent block. If no enough neighbors are found, the maxNumOfNeighbours points are searched forwards in the layer to search for the nearest neighbor of the current point.

In step S13, the Manhattan distance d=|x−x1|+|y−y1|+|z−z1| from each point (x1, y1, z1) to the current to-be-decoded point (x, y, z) can be computed in all candidate neighbor points, the maximum distance of p points with the minimum distance can be determined, and all the candidate neighbor points with distance less than or equal to the maximum distance can be considered as neighbors of the current point, namely determine the K points with the nearest distance as reference points of the current point.

In example 3, the points in the point cloud can be reordered to obtain the Hilbert order of the point cloud, group the point cloud according to the Hilbert sequence of the point cloud, and search K reference points of the current point in the group of the current point. As shown in FIG. 4D, example 2 further includes the following steps:

In step S21, the points in the point cloud can be grouped based on the Hilbert code. For example, geometry points of the reordered point cloud are sequentially grouped, and the points with the same L site behind the Hilbert code are classified into one group. If the total number of the geometry points of one group of points is larger than or equal to 8, fine division in the group is conducted. During fine division, every four points are sequentially divided into one group; and if the total number of the last group of points is smaller than four, the last group of points is combined with the last but one group. It can be guaranteed that K_i≤8 through fine division. If the total number of the geometry points of one group of points is smaller than or equal to 8, fine division is not conducted.

In step S22, a weighted attribute prediction can be performed on the same group. Under the Hilbert sequence, K points closest to the current point are searched in the preorder maxNumOfNeighbours of the first point in the group of the current point. In some embodiments, the maxNumOfNeighbours are defaulted to be 128, and k is defaulted to be 3. In some embodiments, the distance calculation method is Manhattan distance, namely d=|x1−x2|+|y1−y2|+|z1−z2∥.

The mode for determining the K reference points of the current point in the embodiment of this disclosure includes, but is not limited to, the abovementioned three examples.

According to the mode of each example, after the K reference points of the current point are determined, the following step S402-A2 is executed.

In step S402-A2, a predicted value of the j^{th} attribute information of the current point is determined according to the j^{th} attribute information corresponding to each of the K reference points.

For example, the average value of the j^{th} attribute information corresponding to each of the K reference points is determined as the predicted value of the j^{th} attribute information of the current point.

For another example, the weighted average value of the j^{th} attribute information corresponding to each of the K reference points is determined as the predicted value of the j^{th} attribute information of the current point.

In one example, the attribute weight of each reference point k (k=1, 2 . . . K) is determined according to equation (1) as follows:

$${W}_{ik} = \frac{1}{\vert {x}_{i} - {x}_{ik} \vert + \vert {y}_{i} - {y}_{ik} \vert + \vert {z}_{i} - {z}_{ik} \vert} \qquad Eq . ( 1 )$$

Wᵢₖ is the attribute weight of a k^{th} neighbor point of the current point i, (xᵢ, yᵢ, zᵢ) is the geometry information of the current point, and (xᵢₖ, yᵢₖ, zᵢₖ) is the geometry information of the k^{th} neighbor point.

In some embodiments, different weights are adopted for components in x, y and z directions in weight computation in the formula (1), and the weight computation of each neighbor is shown in equation (2):

$${W}_{ik} = \frac{1}{a \vert {x}_{i} - {x}_{ik} \vert + b \vert {y}_{i} - {y}_{ik} \vert + c \vert {z}_{i} - {z}_{ik} \vert} \qquad Eq . ( 2 )$$

a is the weight coefficient of a first component of the current point, b is the weight coefficient of a second component of the current point, and c is the weight coefficient of a third component of the current point. In some embodiments, a, the b and the c can be obtained from a table or are preset fixed values.

After the attribute weight of each neighbor point is determined according to the formula, the attribute prediction value of the current point is computed according to equation (3):

$${\hat{A}}_{i} = \frac{{\sum }_{k = 1}^{K} {W}_{ik} {\hat{A}}_{ik}}{{\sum }_{k = 1}^{K} {W}_{ik}} \qquad Eq . ( 3 )$$

Âᵢₖ is a reconstruction value of j^{th} attribute information of the k^{th} neighbor point, k=1, 2 . . . K, and Âᵢ is a predicted value of the j^{th} attribute information of the current point.

In another example, the weight corresponding to each point in K points is computed based on the distance and other parameters. For example, the weight of each reference point is w=1/d, the optimization weight of the neighbor candidate points with the distance equal to the maximum distance value is wk=(1/d)*dwk, and the value of dwk is the minimum value between Qstep (attribute quantization step size) and the number of the neighbor candidate points with the distance equal to the maximum distance value. The weighted average value of the attribute information of the K reference points is computed to obtain the predicted value of the attribute information of the current point.

In some embodiments, K is less than or equal to 16.

In some embodiments, if the point cloud has repeated points, the points with the same geometry information in the point cloud are called the repeated points; and if the current point is one of the repeated points, a previous repeated point of the current point can be determined as a reference point of the current point, namely K=1, and then a predicted value of j^{th} attribute information of the current point is determined according to the reconstruction value of j j^{th} attribute information of the repeated point.

Before the steps above are executed, the repeated points of the point cloud need to be ordered firstly, and the mode of ordering the repeated points includes, but is not limited to, a mode 1 and a mode 2.

In the mode 1, the N pieces of attribute information of the repeated points can be ordered respectively according to the preset coding sequence.

For example, if the point cloud includes 10 repeated points, and the N pieces of attribute information includes an attribute A and an attribute B, the coding sequence is that the attribute A is coded and then the attribute B is coded. In this way, the 10 repeated points are ordered according to the sequence from small to large of the attribute A, and thus the sequence of the 10 repeated points under the attribute A is obtained. During predicting the attribute A of the current point, the previous repeated point 1 of the current point is searched in the sequence under the attribute A, and the reconstruction value of the attribute A of the repeated point 1 is determined as the predicted value of the attribute A of the current point. In a similar way, the 10 repeated points are ordered according to the sequence from small to large of the attribute B, and thus the sequence of the 10 repeated points under the attribute B is obtained. During predicting the attribute B of the current point, the previous repeated point 2 of the current point is searched in the sequence under the attribute B, and the reconstruction value of the attribute B of the repeated point 2 is determined as the predicted value of the attribute B of the current point.

In one example, the 10 repeated points can be ordered according to the size of the attribute A, the remaining points having the same attribute A in the 10 repeated points are ordered according to the amplitude of the attribute B, and thus one sequence of the 10 repeated points is obtained; the previous repeated point of the current point is searched in the sequence; the previous repeated point is determined as the reference point of the current point; and then the predicted values of the N pieces of attribute information of the current point are determined according to the N pieces of attribute information of the reference point.

In the mode 2, the repeated points can be ordered according to the amplitude of certain attribute information in the N pieces of attribute information.

For example, the repeated points are ordered from small to large of the color attribute, and the previous repeated point of the current point is determined as the reference point of the current point in the sequence.

According to the mode above, after determining the predicted value of the j^{th} attribute information of the current point, the following step S402-A3 is executed.

In step S402-A3, the residual value of the j^{th} attribute information of the current point can be determined according to the original value and the predicted value of the j^{th} attribute information of the current point.

For example, the difference value between the original value and the predicted value of the j^{th} attribute information of the current point is determined as the residual value of the j^{th} attribute information of the current point.

In step S402-A4, a to-be-coded value corresponding to the j^{th} attribute information of the current point can be determined according to the residual value of the j^{th} attribute information of the current point.

In one example, the residual value of the j^{th} attribute information of the current point is determined as the to-be-coded value corresponding to the j^{th} attribute information of the current point.

In another example, the residual value of the j^{th} attribute information of the current point is transformed to obtain the transformation coefficient of attribute residual of the j^{th} attribute information of the current point; and the transformation coefficient of attribute residual of the j^{th} attribute information of the current point is determined as the to-be-coded value corresponding to the j^{th} attribute information of the current point.

For example, when the K reference points of the current point are determined through the mode of Example 2, K_i-element DCT (K_i=2 . . . 8) is carried out on the residual value of the j^{th} attribute information of each point in the group of the current point, and thus the to-be-coded value corresponding to the j^{th} attribute information of the current point is obtained.

In a case of K_i=1, entropy coding is directly carried out on the attribute residual value or the attribute residual value is quantized and then entropy coding is carried out without necessary transformation computation.

In some embodiments, the DCT transformation matrix is amplified by 512 times to realize fixed-point estimation.

According to mode 1, the attribute residual value or the transformation coefficient of attribute residual of the j^{th} attribute information of the current point can be determined.

In mode 2 of the step S402, if the to-be-coded value includes the transformation coefficient of j^{th} attribute information of the current point, the S402 includes the following steps S402-B1 to S402-B2, as shown in FIG. 4E:

In step S402-B1, the j^{th} attribute information of the current point is transformed to obtain the transformation coefficient of the j^{th} attribute information of the current point, j being any value from 1 to N.

For example, grouping is carried out on the point cloud to obtain the group of the current point, and the j^{th} attribute information of the points in the group of the current point is transformed to obtain the transformation coefficient of the j^{th} attribute information of the current point.

This step does not limit the mode of grouping the point cloud, and the grouping of the point cloud can be implemented by any related grouping mode.

In step S402-B2, the transformation coefficient of the j^{th} attribute information of the current point is determined as the to-be-coded value corresponding to the j^{th} attribute information of the current point.

In the mode 2 of step S402, the transformation coefficient of the j^{th} attribute information of the current point is determined, and the transformation coefficient is determined as the to-be-coded value corresponding to the j^{th} attribute information of the current point.

In some embodiments, the to-be-coded values of all the N pieces of attribute information of the current point are determined through mode 1 or mode 2.

In some embodiments, the to-be-coded values of part of the N pieces of attribute information of the current point are determined through mode 1, and the to-be-coded values of part of the attribute information are determined through mode 2.

The modes for determining the to-be-coded values respectively corresponding to the N pieces of attribute information of the current point include, but are not limited to, mode 1 and mode 2.

According to the abovementioned mode, after the to-be-coded values respectively corresponding to the N pieces of attribute information of the current point are determined, the following step S403 is executed.

In step S403, the to-be-coded values can be coded respectively corresponding to the N pieces of attribute information of the current point to obtain the code stream of the point cloud.

The implementation mode of S403 includes, but is not limited to, a mode 1 and a mode 2. In mode 1 of the step S403, the to-be-coded values can be written respectively corresponding to the N pieces of attribute information of the current point into the code stream according to the preset coding sequence.

In mode 1, the to-be-coded values respectively corresponding to the N pieces of attribute information of the current point are directly coded into the code stream.

In some embodiments, before the to-be-coded values respectively corresponding to the N pieces of attribute information of the current point are coded into the code stream, the to-be-coded values respectively corresponding to the N pieces of attribute information of the current point are quantized, and the quantized to-be-coded values respectively corresponding to the N pieces of attribute information of the current point are coded into the code stream.

In mode 1, the decoding end decodes the code stream to directly obtain the to-be-coded values respectively corresponding to the N pieces of attribute information of the current point, and then the reconstruction values respectively corresponding to the N pieces of attribute information of the current point are obtained according to the to-be-coded values respectively corresponding to the N pieces of attribute information of the current point. The whole process is simple, the coding and decoding complexity is reduced, and the coding and decoding efficiency is improved.

In mode 2 of the step S403, the to-be-coded values can be coded respectively corresponding to the N pieces of attribute information of the current point by a run-length coding mode.

For example, if the to-be-coded value corresponding to the j^{th} attribute information in the N pieces of attribute information of the current point is not 0, the value of a length mark corresponding to the j^{th} attribute information is determined to be a first numerical value, and the length mark corresponding to the j^{th} attribute information and the to-be-coded value are written into the code stream by the run-length coding mode.

The length mark is configured to indicate whether the to-be-coded value corresponding to the j^{th} attribute information is 0 or not.

The value of the length mark written in the code stream is the first numerical value, and the first numerical value is used for indicating that the to-be-coded value corresponding to the j^{th} attribute information of the current point is not 0.

In some embodiments, the first numerical value is 0, and j is a positive integer from 1 to N.

In some embodiments, the length mark is represented by a character len (i). For example, the j^{th} attribute information is A, and if the to-be-coded value corresponding to the A is not equal to 0, len (A)=0 and the to-be-coded value corresponding to the attribute information A of the current point are coded into the code stream. For example, if the to-be-coded value corresponding to the attribute information A of the current point is a residual value res(A), len (A)=0 and res(A) are coded into the code stream.

According to the abovementioned mode, the to-be-coded value corresponding to each of the N pieces of attribute information of the current point can be subjected to run-length coding to obtain the code stream.

In some embodiments, during run-length coding, the same attribute information of each point in the point cloud can be used as a whole for run-length coding. For example, according to the above method, the to-be-coded values respectively corresponding to the N pieces of attribute information of each point in the point cloud are determined point by point, and the to-be-coded values respectively corresponding to all the points in the point cloud under the attribute information are subjected to run-length coding to obtain the code stream of the point cloud under the attribute information according to each of the N pieces of attribute information. Taking the color attribute as an example, the to-be-coded value of the color attribute of each point in the point cloud is used as a whole for run-length coding to obtain the code stream of the point cloud under the color attribute. During run-length coding, the length of the color attribute residual of the point cloud being zero is counted and recorded as len (A); and if the residual is not zero, the len (A)=0 and the color attribute residual corresponding to the current point are coded.

In some embodiments, S403 includes coding the to-be-coded values respectively corresponding to the N pieces of attribute information of the current point by the same entropy coder or different entropy coders.

That is, the same entropy coder or different entropy coders can be adopted to code the N pieces of attribute information of the point cloud.

In some embodiments, the coding mode adopted by the entropy coder includes at least one of an exponential Golomb coding, an arithmetic coding, or a context-adaptive arithmetic coding.

In some embodiments, if the entropy coder adopts the context-adaptive arithmetic coding mode, the coding the to-be-coded values respectively corresponding to the N pieces of attribute information of the current point by the same entropy coder or different entropy coders at least includes the following examples:

In example 1, the to-be-coded values can be coded respectively corresponding to the N pieces of attribute information of the current point by the same entropy coder and the same context model.

In example 2, the to-be-coded values can be coded respectively corresponding to the N pieces of attribute information of the current point by the same entropy coder and different context models.

In example 3, the to-be-coded values can be coded respectively corresponding to the N pieces of attribute information of the current point by different entropy coders and different context models.

In example 4, the to-be-coded values can be coded respectively corresponding to the N pieces of attribute information of the current point by different entropy coders and the same context model.

In some embodiments, when the above context model is adopted to code the attribute information, the context model needs to be initialized. The method includes the following examples:

In example 1, the context model can be initialized before the N pieces of attribute information are coded in a case that the same entropy coder and the same context model are adopted to code the to-be-coded values respectively corresponding to the N pieces of attribute information of the current point, or the context model can be initialized during coding the first piece of attribute information in the N pieces of attribute information.

In example 2, the different context models can be initialized before the N pieces of attribute information is coded in a case that the same entropy coder and different context models are adopted to code the to-be-coded values respectively corresponding to the N pieces of attribute information of the current point.

In example 3, the different context models can be initialized before the N pieces of attribute information is coded in a case that different entropy coders and different context models are adopted to code the to-be-coded values respectively corresponding to the N pieces of attribute information of the current point.

In example 4, the context model can be initialized before the N pieces of attribute information is coded in a case that different entropy coders and the same context model are adopted to code the to-be-coded values respectively corresponding to the N pieces of attribute information of the current point.

According to the embodiment of this disclosure, the method for coding the point cloud attribute information includes: acquiring the point cloud, each point in the point cloud including N pieces of attribute information, and N being a positive integer greater than 1; determining to-be-coded values respectively corresponding to the N pieces of attribute information of the current point after detecting that the N pieces of attribute information of the previous point of the current point are coded; and coding the to-be-coded values respectively corresponding to the N pieces of attribute information of the current point to obtain a code stream of the point cloud. According to this disclosure, the attribute information of the points in the point cloud is coded point by point during coding, for example, all the pieces of attribute information of the previous point in the point cloud are coded, and then all the pieces of attribute information of the next point in the point cloud are coded. Therefore, during decoding, the attribute information of any one or more points in the point cloud can be decoded, and the flexibility in coding and decoding of the attribute information of the point cloud is further improved. In addition, the attribute information of each point can be coded or decoded in parallel in this disclosure, so that the random access requirement of point cloud coding is ensured, the coding and decoding computing complexity of a multi-attribute point cloud is greatly reduced, and the coding and decoding efficiency of the point cloud is improved.

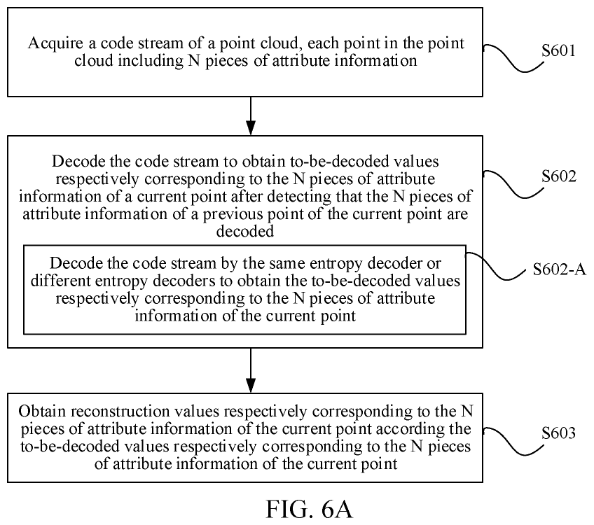

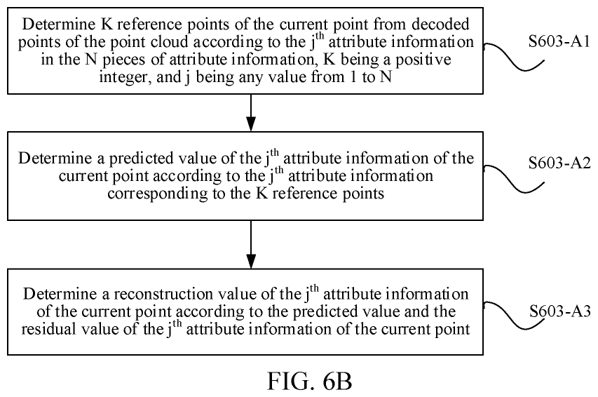

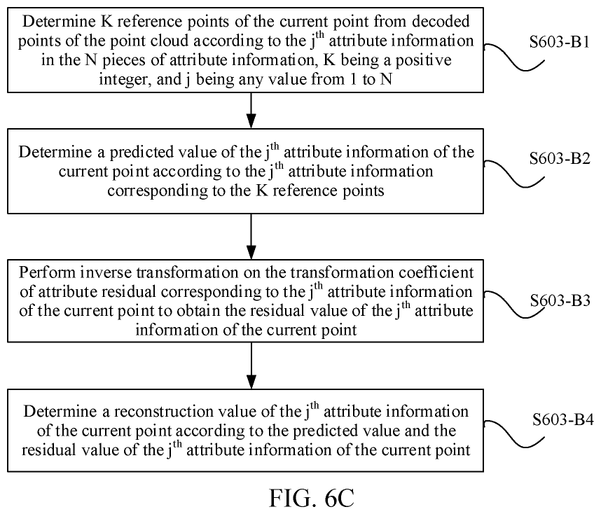

The coding end is taken as an example to describe the method for coding point cloud provided by the embodiment of this disclosure above, and the decoding end is taken as an example to describe the technical solution of this disclosure in combination with FIG. 6A as follows.

FIG. 6A is a flowchart of a method for decoding point cloud attribute information according to an embodiment of this disclosure. An executive agent of the method is an apparatus having a point cloud attribute information decoding function, such as a point cloud decoding apparatus, and the point cloud decoding apparatus can be the abovementioned point cloud decoding device or a part of the point cloud decoding device. In order to facilitate description, the following embodiment is introduced by taking the point cloud decoding device as the executive agent. As shown in FIG. 6A, the method includes:

In step S601, the code stream of the point cloud is acquired, where each point in the point cloud includes N pieces of attribute information. N is a positive integer greater than 1.

In step S602, the code stream is decoded after the N pieces of attribute information of a previous point of the current point are decoded so as to obtain the to-be-decoded values respectively corresponding to the N pieces of attribute information of the current point.

The embodiment relates to a process of decoding the attribute information of the point cloud, and the attribute information of the point cloud is decoded after the position information of the point cloud is decoded. The position information of the point cloud is also called as geometry information of the point cloud.

According to the embodiment of this disclosure, the decoded points can be understood as the points with decoded geometry information and the points with decoded attribute information. For example, the point cloud code stream includes the geometry code stream and the attribute code stream, and the decoding end decodes the geometry code stream of the point cloud to obtain the reconstruction value of the geometry information of the points in the point cloud. After being received, the attribute code stream of the point cloud is decoded to obtain the reconstruction value of the attribute information of the point in the point cloud; and the geometry information and the attribute information of the points in the point cloud are combined to obtain the decoded point cloud. The embodiment of this disclosure relates to a process of decoding the point cloud attribute code stream.

In the process of decoding the attribute code stream of the point cloud, the decoding process of each point in the point cloud is the same, and the current point to be decoded in the point cloud is taken as an example.

According to this disclosure, the current point to be decoded includes N types of attribute information, for example, the current point includes a color attribute, a reflectivity attribute, a normal vector attribute, and a material attribute.

In some embodiments, the current point includes the N types of attribute information, which can be understood as that all points in the point cloud include the N types of attribute information. The process of decoding the attribute information of all points in the point cloud is consistent with the process of decoding the attribute information of the current point, and the current point is taken as an example for illustrating in the embodiment of this disclosure.

According to this disclosure, the points in the point cloud are coded point by point during coding, and the points in the point cloud are decoded point by point during corresponding decoding.

For example, during decoding the current point, whether the N pieces of attribute information of the previous point of the current point are decoded is determined firstly; and after detecting that the N pieces of attribute information of the previous point of the current point are decoded, the code stream is decoded to obtain the to-be-decoded values respectively corresponding to the N pieces of attribute information of the current point.

In some embodiments, the to-be-decoded value corresponding to each of the N pieces of attribute information includes any one of the residual value of attribute information, the transformation coefficient of attribute information and the transformation coefficient of attribute residual.

In S602, the mode for decoding the code stream to obtain the to-be-decoded values respectively corresponding to the N pieces of attribute information of the current point includes, but is not limited to, a mode 1 and a mode 2.

In mode 1, the to-be-decoded values can be decoded respectively corresponding to the N pieces of attribute information of the current point in the code stream according to the preset decoding sequence to obtain the to-be-decoded values respectively corresponding to the N pieces of attribute information of a current point.

In mode 2, the code stream for the j^{th} attribute information in the N pieces of attribute information of the current point can be decoded to obtain the length mark corresponding to the j^{th} attribute information; continue to decode the code stream in a case that the value of the length mark is a first numerical value (such as 0) so as to obtain the to-be-coded value corresponding to the j^{th} attribute information.

The length mark is configured to indicate whether the to-be-coded value corresponding to the j^{th} attribute information is 0 or not, the first numerical value is used for indicating that the to-be-coded value corresponding to the j^{th} attribute information of the current point is not 0, and j is a positive integer from 1 to N.

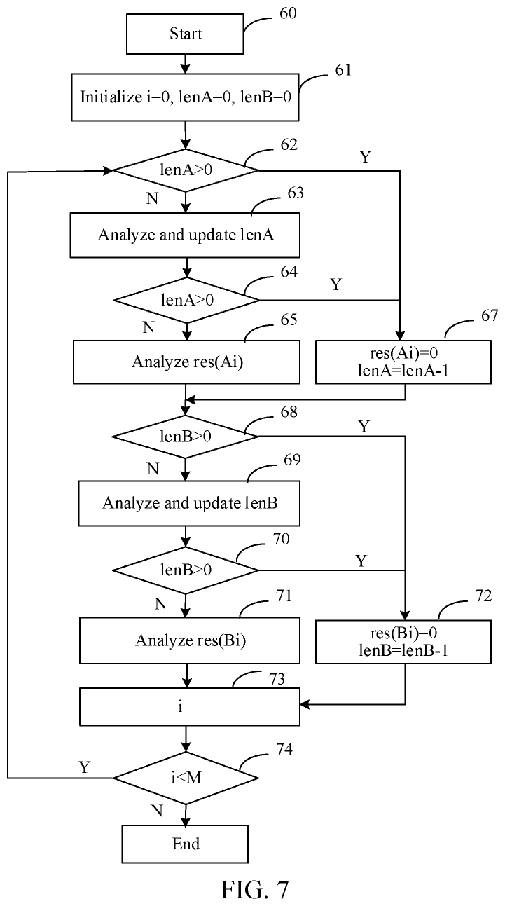

Exemplary, it is assumed that the point cloud data contains M points (M is a positive integer greater than 1); the N pieces of attribute information include attributes A and B; the corresponding attribute information of the point i is attributes Aᵢ and Bᵢ, for example, if the to-be-decoded value is res(Aᵢ) and res(Bᵢ), the run length len(A) and the residual value res(Aᵢ), len(B) and res(Aᵢ) of the attribute corresponding to each point in the point cloud are analyzed point by point. For example, as shown in FIG. 7, the method includes the following steps:

In Step 60, the method shown in FIG. 7 can be started.

In Step 61, i, lenA, and lenB can be initialized as i=0, lenA=0, and lenB=0.

In Step 62, whether lenA is greater than 0 can be determined, and if so, execute step 67, namely determine that res(Aᵢ)=0, and make lenA=lenA−1 for determining the next point. Then, execute the following step 68, and analyze the attribute B of the point i.

If determining that lenA is equal to 0, it is indicated that the residual value of the attribute A of the point i may not be 0, and at the moment, the code stream is decoded, and steps 63 to 65 are executed to analyze the res(Aᵢ).

In Step 63, the code stream can be analyzed and the lenA can be updated.

In Step 64, whether the updated lenA is greater than 0 or not can be determined. If so, execute step 67, and if not so, execute the following step 65. If the lenA is greater than 0, indicate that res(Aᵢ) is 0; and if the lenA is equal to 0, indicate that res(Aᵢ) is not 0.

In Step 65, the code stream can be analyzed to obtain res(Aᵢ).

In Step 67, res(Aᵢ) can be marked as res(Aᵢ)=0, and lenA can be set as lenA−1. Execute the following step 68.

In the example, after the attribute information A of the point i is decoded, the attribute information B of the point i is decoded instead of the attribute information A of the next point, that is, after all the pieces of attribute information of the point i are decoded, the attribute information of the next point is decoded to realize point-by-point decoding in this disclosure.

In Step 68, whether lenB is greater than 0 or not can be determined, if so, execute step 72, and if not so, execute the following step 69.

The analysis process of the attribute B is basically consistent with the analysis process of the attribute A, and refers to the description above.

In Step 69, the code stream can be analyzed, and the lenB can be updated.

In Step 70, whether the updated lenB is greater than 0 or not can be determined. If so, execute step 72, and if not so, execute the following step 71. If the lenB is greater than 0, indicate that res(Bᵢ) is 0; and if the lenB is equal to 0, indicate that res(Bᵢ) is not 0.

In Step 71, the code stream can be analyzed to obtain res(Bᵢ).

In Step 72, res(Bᵢ) can be set as res(Bᵢ)=0, and lenB can be set as lenB=lenB−1.

After the analysis of the attribute A and the attribute B of the point i is finished, step 73 is executed for analyzing the attribute A and the attribute B of the next point.

In Step 73, i is set as i=i+1.

In Step 74, whether the current i is less than M can be determined, if so, return to step 62, and if not so, end.

In Step 75, the process shown in FIG. 7 is ended (or completed).

According to the embodiment of this disclosure, the attribute information of each point in the point cloud is decoded point by point, so that when part of points in the point cloud need to be decoded, only N pieces of attribute information of part of points need to be decoded, the attribute information of other points in the point cloud does not need to be decoded, and as a result, the decoding flexibility is further improved.

In some embodiments, S602 of decoding the code stream to obtain the to-be-decoded values respectively corresponding to the N pieces of attribute information of the current point includes:

In step S602-A, the code stream can be decoded by the same entropy decoder or different entropy decoders to obtain the to-be-decoded values respectively corresponding to the N pieces of attribute information of the current point.

In some embodiments, the coding mode adopted by the entropy coder includes at least one of an exponential Golomb coding, an arithmetic coding, or a context-adaptive arithmetic coding.

In some embodiments, if the entropy coder adopts the context-adaptive arithmetic coding mode, S602-A includes, but is not limited to, the following modes:

(1) Decode the code stream through same entropy decoder and the same context model to obtain the to-be-decoded values respectively corresponding to the N pieces of attribute information of the current point.

(2) Decode the code stream through the same entropy decoder and different context models to obtain the to-be-decoded values respectively corresponding to the N pieces of attribute information of the current point.

(3) Decode the code stream through different entropy decoders and different context models to obtain the to-be-decoded values respectively corresponding to the N pieces of attribute information of the current point.

(4) Decode the code stream through different entropy decoders and the same context model to obtain the to-be-decoded values respectively corresponding to the N pieces of attribute information of the current point.

When the context model is adopted to decode the code stream, the context model needs to be initialized, and the initialization mode includes any one of the following modes:

(1) Initialize the context model before decoding the code stream in a case that the same entropy decoder and the same context model are adopted to decode the code stream, or initialize the context model during decoding the first attribute information in the N pieces of attribute information.

(2) Initialize the different context models before decoding the code stream in a case that the same entropy decoder and different context models are adopted to decode the code stream.

(3) Initialize the different context models before decoding the code stream in a case that different entropy decoders and different context models are adopted to decode the code stream.

(4) Initialize the context model before decoding the code stream in a case that different entropy decoders and the same context model are adopted to decode the code stream.

In step S603, the reconstruction values can be obtained respectively corresponding to the N pieces of attribute information of the current point according the to-be-decoded values respectively corresponding to the N pieces of attribute information of the current point.

The implementation mode of the S603 includes, but is not limited to, a mode 1, a mode 2, and a mode 3.

In mode 1, if the to-be-decoded value includes the residual value of attribute information, S603 includes steps S603-A1 to S603-A3, as shown in FIG. 6B:

In step S603-A1, K reference points of the current point can be determined from the decoded points of the point cloud according to the j^{th} attribute information in the N pieces of attribute information, K being a positive integer, and j being any value from 1 to N.

In step S603-A2, the predicted value of the j^{th} attribute information of the current point can be determined according to the j^{th} attribute information corresponding to the K reference points.

In step S603-A3, the reconstruction value of the j^{th} attribute information of the current point can be determined according to the predicted value and the residual value of the j^{th} attribute information of the current point.

In mode 2, if the to-be-decoded value includes the transformation coefficient of attribute residual, S603 includes steps S603-B1 to S603-B4, as shown in FIG. 6C:

In step S603-B1, the K reference points of the current point can be determined from decoded points of the point cloud according to the j^{th} attribute information in the N pieces of attribute information, K being a positive integer, and j being any value from 1 to N.

In step S603-B2, the predicted value of the j^{th} attribute information of the current point can be determined according to the j^{th} attribute information corresponding to the K reference points.

In step S603-B3, an inverse transformation can be performed on the transformation coefficient of attribute residual corresponding to the j^{th} attribute information of the current point to obtain the residual value of the j^{th} attribute information of the current point.

In step S603-B4, the reconstruction value of the j^{th} attribute information of the current point can be determined according to the predicted value and the residual value of the j^{th} attribute information of the current point.

In mode 3, if the to-be-coded value includes the transformation coefficient of attribute information, S603 includes performing inverse transformation on the transformation coefficient of the j^{th} attribute information of the current point according to the j^{th} attribute information in the N pieces of attribute information of the current point to obtain the reconstruction value of the j^{th} attribute information of the current point.

It is to be understood that the method for decoding the point cloud attribute information is an inverse process of the method for coding the point cloud attribute information. The steps in the method for decoding the point cloud attribute information can refer to corresponding steps in the method for coding the point cloud attribute information, and in order to avoid repetition, no more detailed description is made herein.

According to the embodiment of this disclosure, the method for decoding point cloud includes: acquiring the code stream of the point cloud, each point in the point cloud including N pieces of attribute information; decoding the code stream after detecting that the N pieces of attribute information of the previous point of the current point are decoded so as to obtain the to-be-decoded values respectively corresponding to the N pieces of attribute information of the current point; and obtaining the reconstruction values respectively corresponding to the N pieces of attribute information of the current point according the to-be-decoded values respectively corresponding to the N pieces of attribute information of the current point. That is, according to this disclosure, during decoding, the attribute information of any one or more points in the point cloud can be decoded, and the flexibility in coding and decoding of the attribute information of the point cloud is further improved. In addition, the attribute information of each point can be decoded in parallel in this disclosure, so that the coding and decoding computing complexity of the multi-attribute point cloud is greatly reduced, and the coding and decoding efficiency of the point cloud is improved.

The embodiments of this disclosure are described in detail in combination with the accompanying drawings as above. However, this disclosure is not limited to the details of the above embodiments. Within the scope of the technical concept of this disclosure, a plurality of simple modifications can be made to the technical solution of this disclosure, all of which are within the scope of protection of this disclosure. For example, the various technical features described in the above embodiments can be combined in any suitable way without contradiction. In order to avoid unnecessary repetition, this disclosure will not separately explain various possible combination methods. For another example, various implementation methods of this disclosure can also be combined arbitrarily, as long as they do not violate the ideas of the present disclosure, they are to also be considered as the content disclosed in the present disclosure.

It is also to be understood that in the various embodiments of the method of this disclosure, the magnitude of the sequence numbers of the above processes does not imply the order of execution. The execution order of each process is to be determined based on its function and internal logic, and does not constitute any restrictions on the implementation process of the embodiment of this disclosure.

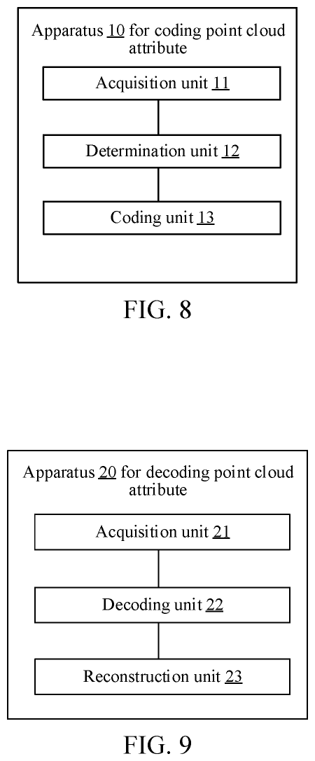

The method embodiment of this disclosure is described in detail in combination with FIG. 1 to FIG. 7 as above, and the apparatus embodiment of this disclosure is described in detail in combination with FIG. 8 to FIG. 10 as follows.

FIG. 8 is a schematic block diagram of an apparatus for coding point cloud attribute information according to an embodiment of this disclosure.

As shown in FIG. 8, the apparatus 10 for coding the point cloud attribute information can include an acquisition unit 11, a determination unit 12, and a coding unit 13.

The acquisition unit 11 is configured to acquire a point cloud, each point in the point cloud including N pieces of attribute information, and N being a positive integer greater than 1;

The determination unit 12 is configured to determine to-be-coded values respectively corresponding to the N pieces of attribute information of a current point after detecting that the N pieces of attribute information of the previous point of the current point are coded; and

The coding unit 13 is configured to code the to-be-coded values respectively corresponding to the N pieces of attribute information of the current point to obtain a code stream of the point cloud.

In some embodiments, the to-be-coded value corresponding to each of the N pieces of attribute information includes: any one of the residual value of attribute information, the transformation coefficient of attribute information and the transformation coefficient of attribute residual.

In some embodiments, the coding unit 13 is configured to write the to-be-coded values respectively corresponding to the N pieces of attribute information of the current point into the code stream according to the preset coding sequence. In some embodiments, the coding unit 13 is configured to determine the value of a length mark corresponding to the j^{th} attribute information as a first numerical value in a case that the to-be-coded value corresponding to the j^{th} attribute information in the N pieces of attribute information of the current point is not 0, and write the length mark corresponding to the j^{th} attribute information and the to-be-coded value into the code stream by the run-length coding mode, the length mark being used for indicating whether the to-be-coded value corresponding to the j^{th} attribute information is 0 or not. The first numerical value is configured to indicate that the to-be-coded value corresponding to the j^{th} attribute information of the current point is not 0, and j is a positive integer from 1 to N.

In some embodiments, the coding unit 13 is configured to code the to-be-coded values respectively corresponding to the N pieces of attribute information of the current point by the same entropy coder or different entropy coders.

In some embodiments, the coding mode adopted by the entropy coder includes at least one of an exponential Golomb coding, an arithmetic coding or a context-adaptive arithmetic coding.

In some embodiments, if the entropy coder adopts the context-adaptive arithmetic coding mode, in some embodiments, the coding unit 13 is configured to code the to-be-coded values respectively corresponding to the N pieces of attribute information of the current point by the same entropy coder and the same context model. In some embodiments, the coding unit 13 is configured to code the to-be-coded values respectively corresponding to the N pieces of attribute information of the current point by the same entropy coder and different context models. In some embodiments, the coding unit 13 is configured to code the to-be-coded values respectively corresponding to the N pieces of attribute information of the current point by the same entropy coder and different context models. In some embodiments, the coding unit 13 is configured to code the to-be-coded values respectively corresponding to the N pieces of attribute information of the current point by different entropy coders and the same context model.

In some embodiments, the coding unit 13 is further configured to initialize the context model before coding the N pieces of attribute information in a case that the same entropy coder and the same context model are adopted to code the to-be-coded values respectively corresponding to the N pieces of attribute information of the current point, or initialize the context model during coding the first attribute information in the N pieces of attribute information. In some embodiments, the coding unit 13 is configured to initialize different context models before coding the N pieces of attribute information in a case that the same entropy coder and different context models are adopted to code the to-be-coded values respectively corresponding to the N pieces of attribute information of the current point. In some embodiments, the coding unit 13 is configured to initialize different context models before coding the N pieces of attribute information in a case that different entropy coders and different context models are adopted to code the to-be-coded values respectively corresponding to the N pieces of attribute information of the current point. In some embodiments, the coding unit 13 is configured to initialize the context model before coding the N pieces of attribute information in a case that different entropy coders and the same context model are adopted to code the to-be-coded values respectively corresponding to the N pieces of attribute information of the current point.

In some embodiments, the determination unit 12 is configured to determine K reference points of the current point from coded points of the point cloud according to the j^{th} attribute information in the N pieces of attribute information of the current point, K being a positive integer, and j being any value from 1 to N; determine a predicted value of the j^{th} attribute information of the current point according to the j^{th} attribute information corresponding to each of the K reference points; determine the residual value of the j^{th} attribute information of the current point according to the original value and the predicted value of the j^{th} attribute information of the current point; and determine the to-be-coded value corresponding to the j^{th} attribute information of the current point according to the residual value of the j^{th} attribute information of the current point.

In some embodiments, the determination unit 12 is configured to determine the residual value of the j^{th} attribute information of the current point as the to-be-coded value corresponding to the j^{th} attribute information of the current point; or transform the residual value of the j^{th} attribute information of the current point to obtain the transformation coefficient of attribute residual of the j^{th} attribute information of the current point, and determine the transformation coefficient of attribute residual of the j^{th} attribute information of the current point as the to-be-coded value corresponding to the j^{th} attribute information of the current point.

In some embodiments, the determination unit 12 is configured to transform the j^{th} attribute information of the current point for the j^{th} attribute information in the N pieces of attribute information to obtain the transformation coefficient of the j^{th} attribute information of the current point, j being any value from 1 to N; and determine the transformation coefficient of the j^{th} attribute information of the current point as the to-be-coded value corresponding to the j^{th} attribute information of the current point.

It is to be understood that apparatus embodiments and method embodiments may correspond to each other, and similar descriptions may refer to the method embodiments. In order to avoid duplication, there is no more description. For example, the apparatus 10 shown in FIG. 8 can execute the embodiments of the abovementioned method for coding point cloud attribute information, and the aforementioned and other operations and/or functions of each module in the apparatus 10 are respectively used for implementing the method embodiments corresponding to the coding device, and are not described here for conciseness.

FIG. 9 is a schematic block diagram of an apparatus for decoding point cloud attribute information according to an embodiment of this disclosure.

As shown in FIG. 9, the apparatus 20 for decoding the point cloud attribute information can include an acquisition unit 21, a decoding unit 22, and a reconstruction unit 23.

The acquisition unit 21 is configured to acquire a code stream of a point cloud, each point in the point cloud including N pieces of attribute information, and N being a positive integer greater than 1;

The decoding unit 22 is configured to decode the code stream to obtain to-be-decoded values respectively corresponding to the N pieces of attribute information of a current point after detecting that the N pieces of attribute information of the previous point of the current point are decoded; and

The reconstruction unit 23 is configured to obtain reconstruction values respectively corresponding to the N pieces of attribute information of the current point according to the to-be-decoded values respectively corresponding to the N pieces of attribute information of the current point.

In some embodiments, the to-be-decoded value corresponding to each of the N pieces of attribute information includes any one of the residual value of attribute information, the transformation coefficient of attribute information and the transformation coefficient of attribute residual.

In some embodiments, the decoding unit 22 is configured to decode the to-be-decoded values respectively corresponding to the N pieces of attribute information of the current point in the code stream according to the preset decoding sequence to obtain the to-be-decoded values respectively corresponding to the N pieces of attribute information of the current point; or decode the code stream according to the j^{th} attribute information in the N pieces of attribute information of the current point to obtain a length mark corresponding to the j^{th} attribute information; and continue to decode the code stream in a case that the value of the length mark is a first numerical value so as to obtain the to-be-coded value corresponding to the j^{th} attribute information, the length mark being used for indicating whether the to-be-coded value corresponding to the j^{th} attribute information is 0 or not, the first numerical value being used for indicating that the to-be-coded value corresponding to the j^{th} attribute information of the current point is not 0, and j being a positive integer from 1 to N.

In some embodiments, the decoding unit 22 is configured to decode the code stream by the same entropy decoder or different entropy decoders to obtain the to-be-decoded values respectively corresponding to the N pieces of attribute information of the current point.

In some embodiments, the coding mode adopted by the entropy coder includes at least one of an exponential Golomb decoding, an arithmetic decoding or a context-adaptive arithmetic decoding.

In some embodiments, if the entropy coder adopts the context-adaptive arithmetic coding mode, the decoding unit 22 is configured to decode the code stream through the same entropy decoder and different context models to obtain the to-be-decoded values respectively corresponding to the N pieces of attribute information of the current point. In some embodiments, the decoding unit 22 is configured to decode the code stream through the same entropy decoders and different context models to obtain the to-be-decoded values respectively corresponding to the N pieces of attribute information of the current point. In some embodiments, the decoding unit 22 is configured to decode the code stream through different entropy decoder and different context models to obtain the to-be-decoded values respectively corresponding to the N pieces of attribute information of the current point. In some embodiments, the decoding unit 22 is configured to decode the code stream through different entropy decoder and the same context model to obtain the to-be-decoded values respectively corresponding to the N pieces of attribute information of the current point.

In some embodiments, the decoding unit 22 is further configured to initialize the context model before decoding the code stream in a case that the same entropy decoder and the same context model are adopted to decode the code stream, or initialize the context model during decoding the first attribute information in the N pieces of attribute information. In some embodiments, the decoding unit 22 is configured to initialize the different context models before decoding the code stream during in a case that the same entropy decoder and different context models are adopted to decode the code stream. In some embodiments, the decoding unit 22 is configured to initialize the different context models before decoding the code stream in a case that different entropy decoder and different context models are adopted to decode the code stream. In some embodiments, the decoding unit 22 is configured to initialize the context model before decoding the code stream in a case that different entropy decoders and the same context model are adopted to decode the code stream.

In some embodiments, if the to-be-decoded value includes the residual value of attribute information, the reconstruction unit 23 is configured to determine K reference points of the current point from the decoded points of the point cloud according to the j^{th} attribute information in the N pieces of attribute information, K being a positive integer, and j being any value from 1 to N; determine the predicted value of the j^{th} attribute information of the current point according to the j^{th} attribute information corresponding to the K reference points; and determine the reconstruction value of the j^{th} attribute information of the current point according to the predicted value and the residual value of the j^{th} attribute information of the current point.

In some embodiments, if the to-be-decoded value include the transformation coefficient of attribute residual, the reconstruction unit 23 is configured to determine the K reference points of the current point from the decoded points of the point cloud according to the j^{th} attribute information in the N pieces of attribute information, K being a positive integer, and j being any value from 1 to N; determine the predicted value of the j^{th} attribute information of the current point according to the j^{th} attribute information corresponding to the K reference points; and perform inverse transformation on the transformation coefficient of attribute residual corresponding to the j^{th} attribute information of the current point to obtain the residual value of the j^{th} attribute information of the current point; and determine the reconstruction value of the j^{th} attribute information of the current point according to the predicted value and the residual value of the j^{th} attribute information of the current point.

In some embodiments, if the to-be-decoded value includes the transformation coefficient of attribute information, the reconstruction unit 23 is configured to perform inverse transformation on the transformation coefficient of the j^{th} attribute information according to the j^{th} attribute information in the N pieces of attribute information to obtain the reconstruction value of the j^{th} attribute information of the current point.

It is to be understood that apparatus embodiments and method embodiments may correspond to each other, and similar descriptions may refer to the method embodiments. In order to avoid duplication, there is no more description. For example, the apparatus 20 shown in FIG. 9 can perform embodiments of the abovementioned method for decoding point cloud attribute information, and the aforementioned and other operations and/or functions of each module in the apparatus 20 are respectively used for implementing the method embodiments corresponding to the decoding device, and are not described here for conciseness.

The apparatus of the embodiment of this disclosure is described from the perspective of the functional modules in combination with the accompanying drawing. It is to be understood that the functional modules can be realized in the form of hardware, can also be realized in the form of software instructions, and can also be realized by combining hardware and software modules. For example, the steps of the method embodiment of this disclosure can be completed through an integrated logic circuit of hardware in a processor and/or instructions in the form of software, and the steps combined with the method disclosed by the embodiment of this disclosure can be directly embodied in that a hardware decoding processor executes and completes the steps, or the hardware and software modules in the decoding processor are combined to execute and complete the steps. In some embodiments, the software module can be located in mature storage media in the field such as a random access memory, a flash memory, a read-only memory, a programmable read-only memory, an electrically erasable programmable memory and a register. The storage medium is located in a memory, and the processor reads information in the memory and completes the steps in the method embodiment in combination with hardware of the processor.

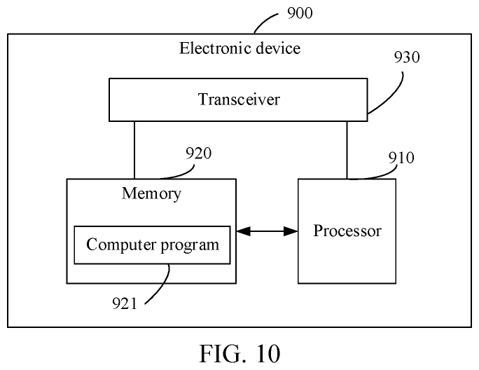

FIG. 10 is a schematic block diagram of an electronic device according to an embodiment of this disclosure, and the electronic device in FIG. 10 can be the point cloud coding device or the point cloud decoding device, or has the functions of the coding device and the decoding device at the same time.

As shown in FIG. 10, the electronic device 900 can include a memory 910 and a processor 920. The memory 910 is configured to store a computer program 911 and transmit the program code 911 to the processor 920. In other words, the processor 920 can call and run the computer program 911 from the memory 910 to execute the method in the embodiment of this disclosure.

For example, the processor 920 can be configured to execute the steps in the method 200 according to the instructions in the computer program 911.

In some embodiments of this disclosure, the processor 920 may include, but is not limited to, a general purpose processor, a digital signal processor (DSP), an application specific integrated circuit (ASIC), a field programmable gate array (FPGA) or other programmable logic devices, discrete gates or transistor logic devices, discrete hardware components, and the like.

In some embodiments of this disclosure, the memory 910 includes, but is not limited to, a volatile memory and/or a non-volatile memory. The non-volatile memory may be a read-only memory (ROM), a programmable ROM (PROM), an erasable PROM (EPROM), an electrically erasable EPROM (EEPROM), or a flash memory. The volatile memory may be a random access memory (RAM) that serves as an external cache. By way of example but not limiting explanation, many forms of RAM may be used, such as static RAM (SRAM), dynamic RAM (DRAM), synchronous DRAM (SDRAM), double data rate SDRAM (DDR SDRAM), enhanced SDRAK (ESDRAM), synch link DRAM (SLDRAM) and direct Rambus RAM (DR RAM).

In some embodiments of this disclosure, the computer program 911 may be divided into one or more modules, which are stored in the memory 910 and executed by the processor 920 to complete the method of recording pages provided by this disclosure. The one or more modules may be a series of computer program instruction segments capable of performing functions, the instruction segments being used to describe the execution of the computer program 911 in the electronic device 900.

As shown in FIG. 10, the electronic device 900 may also include a transceiver 930, and the transceiver 930 can be connected to the processor 920 or memory 910.

The processor 920 may control the transceiver 930 to communicate with other devices. For example, the transceiver 930 may transmit information or data to other devices, or may receive information or data from other devices. The transceiver 930 may include a transmitter and a receiver. The transceiver 930 may further include one or more antennas.

It is to be understood that all components in the electronic device 900 are connected through a bus system, and the bus system includes a power bus, a control bus and a state signal bus besides a data bus.

According to one aspect of this disclosure, a computer storage medium is provided, a computer program is stored on the computer storage medium, and the computer program enables a computer to execute the method provided by the embodiment of the method when being executed by the computer. Or, the embodiment of this disclosure further provides a computer program product containing an instruction, and the instruction enables the computer to execute the method provided by the embodiment of the method when being executed by the computer.

According to another aspect of this disclosure, a computer program product or a computer program is provided, the computer program product or the computer program includes a computer instruction, and the computer instruction is stored in a computer-readable storage medium. A processor of the computer device reads the computer instruction from the computer-readable storage medium, and the processor executes the computer instruction, so that the computer device executes the method provided by the method embodiment.

When software is adopted for implementation, implementation may be entirely or partially performed in the form of a computer program product. The computer program product includes one or more computer instructions. When the program instruction of the computer is loaded and executed on the computer, all or some of the steps are generated according to the process or function described in the embodiments of this disclosure the computer may be a general-purpose computer, a special-purpose computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server or data center to another website, computer, server or data center in a wired (for example, a coaxial cable, an optical fiber or a digital subscriber line (DSL)) or wireless (for example, infrared, wireless or microwave) manner. The computer-readable storage medium may be any available medium capable of being accessed by a computer or include one or more data storage devices integrated by an available medium, such as a server and a data center. The available medium may be a magnetic medium (such as a floppy disk, a hard disk, or a magnetic tape), an optical medium (such as a digital video disc (DVD)), a semiconductor medium (such as a solid state disk (SSD)) or the like.

The exemplary units and algorithm steps described with reference to the embodiments disclosed in this specification can be implemented in electronic hardware, or a combination of computer software and electronic hardware. Whether the functions are executed in a mode of hardware or software depends on exemplary applications and design constraint conditions of the technical solutions. A person skilled in the art may use different methods to implement the described functions for each exemplary application, but it is not to be considered that the implementation goes beyond the scope of the present disclosure.

In the several embodiments provided in this disclosure, it is to be understood that the disclosed system, apparatus, and method may be implemented in other manners. For example, the foregoing described apparatus embodiments are merely exemplary. For example, the module division is merely logical function division and may be other division in actual implementation. For example, a plurality of modules or components may be combined or integrated into another system, or some features may be ignored or not performed. In addition, the displayed or discussed mutual couplings or direct couplings or communication connections may be implemented through some interfaces. The indirect couplings or communication connections between the apparatuses or modules may be implemented in electronic, mechanical, or other forms.

The modules described as separate parts may or may not be physically separate, and the parts displayed as modules may or may not be physical modules, may be located in one position, or may be distributed on a plurality of network modules. Some or all of the modules may be selected according to actual needs to achieve the objectives of the solutions of the embodiments. In addition, functional modules in the embodiments of in this disclosure may be integrated into one processing module, or each of the modules may exist alone physically, or two or more modules are integrated into one module.

The foregoing descriptions are merely exemplary implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of the present disclosure shall be subject to the appended claims.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

What is claimed is:

1. A method for encoding point cloud attribute information of a point cloud, the method comprising:
acquiring a point cloud that includes a plurality of points, each of the plurality of points in the point cloud including N pieces of attribute information, and N being a positive integer greater than 1;
determining a to-be-coded value for each of the N pieces of attribute information of a current point of the plurality of points based on encoding of N pieces of attribute information of another point of the plurality of points;
selecting at least one of (i) an encoder among plural encoders or (ii) a coding mode among plural coding modes for the to-be-coded value for each of the N pieces of attribute information of the current point; and
encoding the to-be-coded values of the N pieces of attribute information of the current point respectively based on the selected at least one of the encoder or the coding mode for each to-be-coded value to obtain a code stream of the point cloud.

2. The method according to claim 1, wherein the to-be-coded value for each of the N pieces of attribute information comprises one of a residual value of the respective one of the N pieces of attribute information, a transformation coefficient of the respective one of the N pieces of attribute information, and a transformation coefficient of an attribute residual of the respective one of the N pieces of attribute information.

3. The method according to claim 1, wherein the encoding the to-be-coded values of the N pieces of attribute information of the current point comprises:
writing a length mark and the encoded to-be-coded value of a j^{th} attribute information of the N pieces of attribute information into the code stream respectively by a run-length coding mode, the length mark indicating whether the to-be-coded value of the j^{th} attribute information is 0 or not, a first numerical value of the length mark indicating that the to-be-coded value of the j^{th} attribute information of the current point is not 0, and j being a positive integer from 1 to N.

4. The method according to claim 1, wherein the encoding the to-be-coded values of the N pieces of attribute information of the current point comprises one of:
based on the selected coding mode being a context-adaptive arithmetic coding,
encoding the to-be-coded value for each of the N pieces of attribute information of the current point by a same entropy encoder of plural entropy encoders and a same context model associated with the context-adaptive arithmetic coding;
encoding the to-be-coded value for each of the N pieces of attribute information of the current point by a same entropy coder of the plural entropy encoders and a respective context model associated with the context-adaptive arithmetic coding;
encoding the to-be-coded value for each of the N pieces of attribute information of the current point by a respective entropy coder of the plural entropy encoders and a respective context model associated with the context-adaptive arithmetic coding; and
encoding the to-be-coded value for each of the N pieces of attribute information of the current point by a respective entropy coder of the plural entropy encoders and a same context model associated with the context-adaptive arithmetic coding.

5. The method according to claim 4, further comprising:
initializing the same context model before the to-be-coded value for each of the N pieces of attribute information is encoded or when a first one of the N pieces of attribute information is encoded based on the to-be-coded value for each of the N pieces of attribute information being encoded by the same context model and the same entropy encoder;
initializing the respective context model before the to-be-coded value for each of the N pieces of attribute information is encoded based on the to-be-coded value for each of the N pieces of attribute information of the current point being encoded by the same entropy coder and the respective context model;
initializing the respective context model before the to-be-coded value for each of the N pieces of attribute information is encoded based on the to-be-coded value for each of the N pieces of attribute information of the current point being encoded by the respective context model and the respective entropy encoder; and
initializing the same context model before the to-be-coded value for each of the N pieces of attribute information is encoded based on the to-be-coded value for each of the N pieces of attribute information of the current point being encoded by the respective entropy encoder and the same context model.

6. The method according to claim 4, wherein the determining the to-be-coded value for each of the N pieces of attribute information of the current point comprises:
determining K reference points of the current point from coded points of the plurality of points of the point cloud according to j^{th} attribute information of the N pieces of attribute information, K being a positive integer;
determining a predicted value of the j^{th} attribute information of the current point based on j^{th} attribute information of each of the K reference points;
determining a residual value of the j^{th} attribute information of the current point based on an original value of the j^{th} attribute information and the predicted value of the j^{th} attribute information of the current point; and
determining a to-be-coded value of the j^{th} attribute information of the current point according to the residual value of the j^{th} attribute information of the current point.

7. The method according to claim 6, wherein the determining the to-be-coded value of the j^{th} attribute information of the current point comprises one of:
determining the residual value of the j^{th} attribute information of the current point as the to-be-coded value of the j^{th} attribute information of the current point; and
determining a transformation coefficient of an attribute residual of the j^{th} attribute information of the current point as the to-be-coded value of the j^{th} attribute information of the current point, the transformation coefficient of the attribute residual of the j^{th} attribute information being obtained by transforming the residual value of the j^{th} attribute information.

8. The method according to claim 4, wherein the determining the to-be-coded value for each of the N pieces of attribute information of the current point comprises:
transforming j^{th} attribute information of the current point to obtain a transformation coefficient of the j^{th} attribute information of the current point; and
determining the transformation coefficient of the j^{th} attribute information of the current point as the to-be-coded value of the j^{th} attribute information of the current point.

9. A method for decoding point cloud attribute information of a point cloud, the method comprising:
receiving a code stream of a point cloud that includes a plurality of points, each of the plurality of points in the point cloud including N pieces of attribute information, and N being a positive integer greater than 1, each of the N pieces of attribute information including a respective to-be-decoded value;
selecting at least one of (i) a decoder among plural decoders or (ii) a decoding mode among plural decoding modes for the to-be-decoded value for each of the N pieces of attribute information of a current point of the plurality of points;
decoding the to-be-decoded values of the N pieces of attribute information of the current point respectively based on the selected at least one of the decoder or the decoding mode for each to-be-decoded value in response to the N pieces of attribute information of another point of the plurality of points being decoded; and
obtaining a reconstruction value for each of the N pieces of attribute information of the current point based on the decoded to-be-decoded value of the respective one of the N pieces of attribute information of the current point.

10. The method according to claim 9, wherein the to-be-decoded value for each of the N pieces of attribute information comprises one of a residual value of the respective one of the N pieces of attribute information, a transformation coefficient of the respective one of the N pieces of attribute information, and a transformation coefficient of an attribute residual of the respective one of the N pieces of attribute information.

11. The method according to claim 9, wherein the decoding the to-be-decoded values of the N pieces of attribute information of the current point comprises:
decoding the to-be-decoded value for each of the N pieces of attribute information of the current point in the code stream according to a preset decoding sequence to obtain the decoded to-be-decoded values of the N pieces of attribute information of the current point.

12. The method according to claim 9, wherein the decoding the to-be-decoded values of the N pieces of attribute information of the current point comprises:
decoding a j^{th} attribute information of the N pieces of attribute information of the current point to obtain a length mark of the j^{th} attribute information, j being a positive integer from 1 to N; and
decoding the to-be-decoded value of the j^{th} attribute information based on a value of the length mark being a first numerical value, the length mark indicating whether the to-be-decoded value of the j^{th} attribute information is 0 or not, the first numerical value indicating that the to-be-decoded value of the j^{th} attribute information of the current point is not 0.

13. The method according to claim 9, wherein:
the plural decoders are plural entropy decoders, and
the plural decoding modes includes at least one of an exponential Golomb decoding, an arithmetic decoding, and a context-adaptive arithmetic decoding.

14. The method according to claim 13, wherein the decoding the to-be-decoded values of the N pieces of attribute information of the current point comprises one of:
based on the selected decoding mode being the context-adaptive arithmetic decoding, decoding the to-be-decoded value for each of the N pieces of attribute information of the current point by a same entropy decoder of the plural entropy decoders and a same context model associated with the context-adaptive arithmetic decoding;
decoding the to-be-decoded value for each of the N pieces of attribute information of the current point by a same entropy decoder of the plural entropy decoders and a respective context model associated with the context-adaptive arithmetic decoding;
decoding the to-be-decoded value for each of the N pieces of attribute information of the current point by a respective entropy decoder of the plural entropy decoders and a respective context model associated with the context-adaptive arithmetic decoding; and
decoding the to-be-decoded value for each of the N pieces of attribute information of the current point by a respective entropy decoder of the plural entropy decoders and a same context model associated with the context-adaptive arithmetic decoding.

15. The method according to claim 14, further comprising:
initializing the same context model before the to-be-decoded value for each of the N pieces of attribute information is decoded or when a first attribute information of the N pieces of attribute information is encoded based on the to-be-decoded value for each of the N pieces of attribute information being decoded by the same context model and the same entropy decoder;
initializing the respective context model before the to-be-decoded value for each of the N pieces of attribute information is decoded based on the to-be-decoded value for each of the N pieces of attribute information of the current point being decoded by the same entropy decoder and the respective context model;
initializing the respective context model before the to-be-decoded value for each of the N pieces of attribute information is decoded based on the to-be-decoded value for each of the N pieces of attribute information of the current point being decoded by the respective entropy decoder and the respective context model; and
initializing the same context model before the to-be-decoded value for each of the N pieces of attribute information is decoded based on the to-be-decoded value for each of the N pieces of attribute information of the current point being decoded by the respective entropy decoder and the same context model.

16. The method according to claim 13, wherein the obtaining the reconstruction value for each of the N pieces of attribute information comprises:
determining K reference points of the current point from decoded points of the plurality of points of the point cloud for j^{th} attribute information of the N pieces of attribute information of the current point, K being a positive integer;
determining a predicted value of the j^{th} attribute information of the current point according to j^{th} attribute information of each of the K reference points; and
determining a reconstruction value of the j^{th} attribute information of the current point according to the predicted value and a residual value of the j^{th} attribute information of the current point, the residual value of the j^{th} attribute information being included in the to-be-decoded value of the j^{th} attribute information.

17. The method according to claim 13, wherein the obtaining the reconstruction value for each of the N pieces of attribute information comprises:
determining K reference points of the current point from decoded points of the plurality of points of the point cloud for j^{th} attribute information of the N pieces of attribute information of the current point, K being a positive integer;
determining a predicted value of the j^{th} attribute information of the current point according to j^{th} attribute information of each of the K reference points;
performing an inverse transformation on a transformation coefficient of an attribute residual corresponding to the j^{th} attribute information of the current point to obtain a residual value of the j^{th} attribute information of the current point, the transformation coefficient of the attribute residual being included in the to-be-decoded value of the j^{th} attribute information; and
determining a reconstruction value of the j^{th} attribute information of the current point according to the predicted value and the residual value of the j^{th} attribute information of the current point.

18. The method according to claim 13, wherein the obtaining the reconstruction value for each of the N pieces of attribute information of the current point comprises:
performing an inverse transformation on a transformation coefficient of j^{th} attribute information of the current point according to the j^{th} attribute information in the N pieces of attribute information of the current point to obtain the reconstruction value of the j^{th} attribute information, the transformation coefficient being included in the to-be-decoded value of the j^{th} attribute information.

19. An electric device, comprising:
processing circuitry configured to:
receive a code stream of a point cloud that includes a plurality of points, each of the plurality of points in the point cloud including N pieces of attribute information, and N being a positive integer greater than 1, each of the N pieces of attribute information including a respective to-be-decoded value;
select at least one of (i) a decoder among plural decoders or (ii) a decoding mode among plural decoding modes for the to-be-decoded value for each of the N pieces of attribute information of a current point of the plurality of points;
decode the to-be-decoded values of the N pieces of attribute information of the current point respectively based on the selected at least one of the decoder or the decoding mode for each to-be-decoded value in response to the N pieces of attribute information of another point of the plurality of points being decoded; and
obtain a reconstruction value for each of the N pieces of attribute information of the current point based on the decoded to-be-decoded value of the respective one of the N pieces of attribute information of the current point.

20. The electric device according to claim 19, wherein the to-be-decoded value for each of the N pieces of attribute information comprises one of a residual value of the respective one of the N pieces of attribute information, a transformation coefficient of the respective one of the N pieces of attribute information, and a transformation coefficient of an attribute residual of the respective one of the N pieces of attribute information.
